(19) United States
(12) Patent Application Publication
(10) Pub. No.: US 2025/0358796 A1
(43) Pub. Date: Nov. 20, 2025

(54) ADAPTIVE LEARNING OF SILENCE INSERTION DESCRIPTOR FRAME DURATION TO ENHANCE UPLINK RESOURCE USAGE

(71) Applicant: Dell Products L.P., Round Rock, TX (US)

(72) Inventors: Hemant Kumar Bhawarlal Jain, Bangalore (IN); Vikas Arora, Ottawa (CA); Youqian Xiao, Toronto (CA); Ravi Sharma, Cupertino, CA (US)

(21) Appl. No.: 18/667,563

(22) Filed: May 17, 2024

(51) Int. Cl. H04W 72/0446

(52) U.S. Cl. CPC H04W 72/0446

(57) ABSTRACT

SID frame duration during communication session between device and base station can be determined and bypassing of certain uplink grants of the session can be controlled. Uplink communication manager (UCM) can determine when session is in silent period based on a silent period detection threshold value, and determine SID frame duration of session based on determination of a number of consecutive slots without uplink voice-related data packet or SID frame being received from the device during silent period. UCM can determine number of slots to bypass for periodic uplink grants, or number of configured slots to bypass for configured grant, during portion of silent period, based on SID frame duration, silent period detection threshold value, and periodic uplink grant period or configured grant periodicity. During silent period, UCM can control bypassing of periodic uplink grants for the number of slots or the number of configured grant slots.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise determining, by a system comprising at least one processor, a silent-insertion-descriptor frame duration associated with a communication session associated with a device based on a determination of a number of consecutive time slots without an uplink voice-related data packet or a silent-insertion-descriptor frame packet being received from the device during the communication session. The method also can comprise initiating, by the system, bypassing of at least one uplink grant time slot for the communication session for a defined time period that can be determined based on the silent-insertion-descriptor frame duration.

In certain embodiments, the disclosed subject matter can comprise a system that can comprise at least one memory that can store computer executable components, and at least one processor that can execute computer executable components stored in the at least one memory. The computer executable components can comprise a frame duration detector that can determine a silent-insertion-descriptor frame duration associated with a communication session associated with a user equipment based on a determination of a number of consecutive slots determined not to comprise an uplink voice-related data packet or a silent-insertion-descriptor frame packet from the user equipment during the communication session. The computer executable components also can comprise a slot bypasser controller that can control bypassing of at least one uplink grant slot for the communication session for a defined amount of time that can be determined based on the silent-insertion-descriptor frame duration.

In still other embodiments, the disclosed subject matter can comprise a non-transitory machine-readable medium, comprising executable instructions that, when executed by at least one processor, can facilitate performance of operations. The operations can comprise determining a silent-insertion-descriptor frame duration associated with a silent period of a communication session associated with a user equipment based on a determination of a number of slots without an uplink voice-related data packet or a silent-insertion-descriptor frame packet being received from the user equipment during the communication session. The operations also can comprise initiating omission of an uplink grant slot during the silent period of the communication session for a defined time period that can be determined based on the silent-insertion-descriptor frame duration.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably learn and determine a silent insertion descriptor (SID) frame duration of communication of SID frames by a device during a communication session of the device, control bypassing of certain uplink grant slots during a silent period(s) of the communication session, and mitigate wastage of uplink air interface resources and/or other resources of the device or a communication network, in accordance with various aspects and embodiments of the disclosed subject matter.

FIG. 2 depicts a block diagram of a non-limiting example uplink communication manager component, in accordance with various aspects and embodiments of the disclosed subject matter.

FIG. 3 illustrates a block diagram of a non-limiting example communication session associated with a device and comprising talk spurt periods and silent periods, in accordance with various aspects and embodiments of the disclosed subject matter.

FIG. 4 depicts a diagram of a non-limiting example communication session, employing periodic uplink grants, where the periodic uplink grants can be controlled and/or bypassed (e.g., during a silent period), in accordance with various aspects and embodiments of the disclosed subject matter.

FIG. 5 illustrates a diagram of a non-limiting example communication session, employing a configured grant, where configured grant slots can be controlled and/or bypassed (e.g., during a silent period), in accordance with various aspects and embodiments of the disclosed subject matter.

FIG. 6 illustrates a block diagram of non-limiting example system that can comprise a radio access network (RAN), which can comprise the uplink communication manager component that can desirably learn and determine an SID frame duration of communication of SID frames by a device during a communication session of the device, control bypassing of certain uplink grant slots during a silent period(s) of the communication session, and mitigate wastage of uplink air interface resources and/or other resources of the device or the communication network, in accordance with various aspects and embodiments of the disclosed subject matter.

FIG. 7 depicts a diagram of a non-limiting example base station that can desirably facilitate connections and communication of information associated with devices, in accordance with various aspects and embodiments of the disclosed subject matter.

FIG. 8 illustrates a diagram of a non-limiting example device that can be operable to engage in a system architecture that facilitates wireless communications according to one or more embodiments described herein, in accordance with various aspects and embodiments of the disclosed subject matter.

FIG. 9 illustrates a flow chart of an example method \ that can desirably learn and determine an SID frame duration of communication of SID frames by a device during a communication session of the device, and bypass certain uplink grant slots during a silent period of the communication session, to facilitate mitigating wastage of uplink air interface resources and/or other resources of the device or the communication network, in accordance with various aspects and embodiments of the disclosed subject matter.

FIGS. 10 and 11 depict a flow chart of another example method that can desirably learn and determine an SID frame duration of communication of SID frames by a device during a communication session of the device, in accordance with various aspects and embodiments of the disclosed subject matter.

FIG. 12 illustrates a flow chart of an example method that can desirably determine an SID frame duration during a communication session of the device, determine whether the communication session is in a silent period, and control bypassing of periodic uplink grants during the silent period, to facilitate mitigating wastage of uplink air interface resources and/or other resources of the device or the communication network, in accordance with various aspects and embodiments of the disclosed subject matter.

FIG. 13 illustrates a flow chart of an example method that can desirably determine an SID frame duration during a communication session of the device, determine whether the communication session is in a silent period, and control bypassing of configured grant slots during the silent period, to facilitate mitigating wastage of uplink air interface resources and/or other resources of the device or the communication network, in accordance with various aspects and embodiments of the disclosed subject matter.

FIG. 14 illustrates an example block diagram of an example computing environment in which the various embodiments of the embodiments described herein can be implemented.

FIG. 15 illustrates a diagram of example traffic characteristics for a voice service.

FIG. 16 depicts a diagram of an example traffic pattern for a configured grant, with a desired periodicity, for the voice service.

FIG. 17 depicts a diagram of an example traffic pattern for periodic uplink grants, with a desired periodicity, for the voice service.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to enhanced and adaptive learning of silence insertion descriptor (SID) frame duration to enhance uplink resource usage in a communication session (e.g., a voice over new radio (VoNR) session) in a communication network (e.g., communication network comprising a core network that can facilitate wireless communication of information between devices, including wireless devices). A device, such as a mobile device (e.g., user equipment (UE), smart phone, or other mobile wireless device) can connect (e.g., wirelessly connect) to a cell (e.g., cell of a base station) or other access point associated with a radio access network (RAN) of the communication network to facilitate connection to the communication network. The device, via connection to the RAN and communication network, can utilize various types of services and applications of or associated with the communication network, and can simultaneously or concurrently access multiple services.

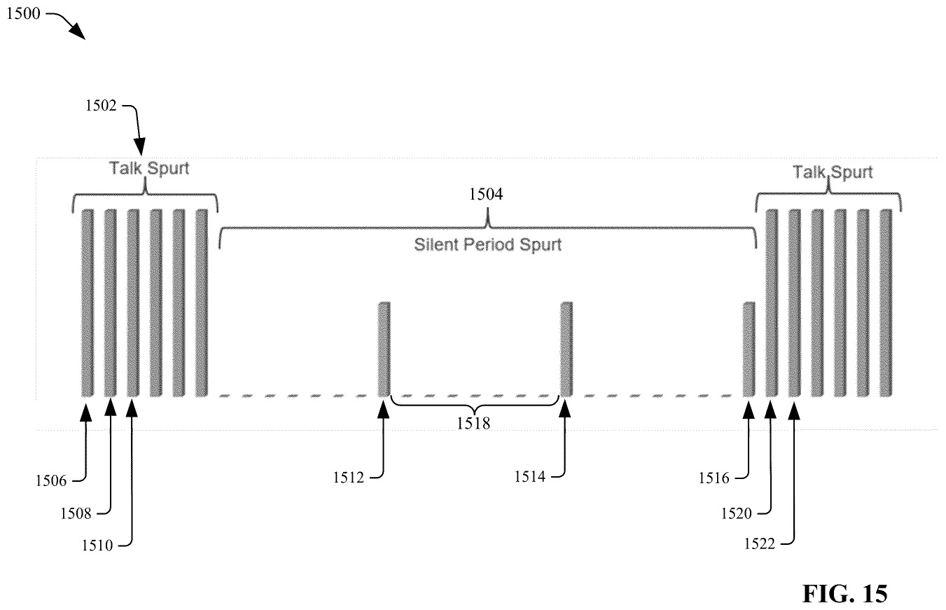

A communication network, such as a fifth generation (5G) and/or other new radio (NR) generation communication network (e.g., xG communication network, wherein x can be a number greater than 5), can support various types of services. Some of the services can generate data traffic in a periodic manner that can utilize (e.g., want, require, or otherwise utilize) periodic resource allocation. One type of service that can generate data traffic in a periodic manner and utilize periodic resource allocation can be a voice service (e.g., VoNR service). Referring briefly to FIG. 15, FIG. 15 illustrates a diagram of example traffic characteristics 1500 for the voice service. The voice characteristics 1500 can be characterized into two states, which can be a talk spurt 1502 (e.g., talk spurt state) and a silent period 1504 (e.g., silent state). During the talk spurt state 1502, the device can be engaging in communication (e.g., the user of the device can be speaking) and can be sending voice data packets, including, for example, voice data packets 1506, 1508, and 1510, which can be transmitted periodically (e.g., every 20 milliseconds (ms) or at another desired periodicity) to the base station (e.g., to be forwarded to the desired destination device). While in the silent period 1504, the device can be monitoring (e.g., listening) for data traffic and can communicate one silent frame (e.g., one SID frame or data packet), such as silent frames 1512, 1514, and 1516, every SID frame duration (e.g., SID frame interval), such as SID in frame duration 1518, to the base station. The silent frame can contain data that can merely be noise. The SID frame duration can be based at least in part on the voice codec and SID mode employed by the device. When the device is ready to communicate voice data packets again, the device can return to the talk spurt state 1502, and the device can again send voice data packets, including, for example, voice data packets 1520 and 1522, which can be transmitted periodically to the base station.

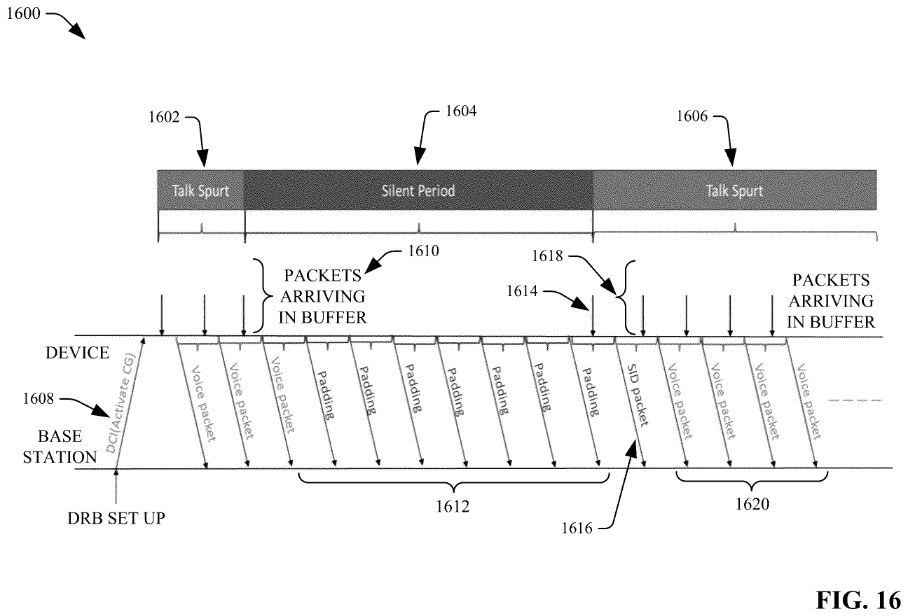

To handle the voice (e.g., VoNR) data traffic pattern, the base station (e.g., the DU of the base station) can provide (e.g., allocate or assign) a periodic uplink grant to the device either by enabling or activating a configured grant or performing periodic uplink grant scheduling with a desired periodicity (e.g., 20 ms or another desired periodicity). Turning briefly to FIG. 16, FIG. 16 depicts a diagram of an example traffic pattern 1600 for a configured grant, with a desired periodicity, for the voice service. The example traffic pattern 1600 can comprise a talk spurt state 1602, followed by a silent period 1604, followed by another talk spurt state 1606. With the configured grant, the device can send uplink data periodically without waiting for uplink downlink control information (DCI). The base station can configure the periodicity, for example, via radio resource control (RRC) signaling. The base station (e.g., the DU of the base station) can reserve a time and frequency domain allocation, and can provide (e.g., communicate) the time and frequency domain allocation to the device, via DCI 1608, to facilitate setting up the voice-service data radio bearer (DRB), when the configured grant is activated.

During the talk spurt state 1602, the voice packets can arrive (e.g., can be stored in) the buffer (e.g., device medium access control (MAC) buffer) of the device, as indicated at reference numeral 1610, and the device can periodically communicate the voice packets to the base station, in accordance with the periodicity, without having to receive separate uplink grants via DCI from the base station. In some existing techniques, during the silent period 1604, since the device is not communicating voice packets to the base station, but has periodic uplink grants in accordance with the configured grant, the device can periodically communicate padding (e.g., padding packets), which can comprise no user data (e.g., no voice data or other user data), to the base station at each configured grant slot (e.g., configured grant time slot), as indicated at reference numeral 1612. Periodically during the silent period 1604, such as each SID frame duration period, the device can insert a silent frame in the buffer, as indicated at reference numeral 1614, and can communicate the silent frame (e.g., SID frame), instead of padding, in the corresponding configured grant slot, to the base station, as indicated at reference numeral 1616. If the silent period 1604 ends thereafter and changes to the next talk spurt state 1606 (as depicted), the silent period 1604 can end, and during the next talk spurt state 1606, the device can have voice packets arrive in the buffer, as indicated at reference numeral 1618, which can be periodically communicated to the base station during each configured grant slot, as indicated at reference numeral 1620. If, instead, the silent period 1604 continues after the silent frame (e.g., 1616), the device can again communicate padding to the base station during each configured grant slot, if and until the device communicates another silent frame, in a configured grant slot, to the base station at the end of the SID frame duration period (e.g., for one or more SID frame duration periods), or if and until the device transitions back to the talk spurt state 1606, or if and until the communication session ends.

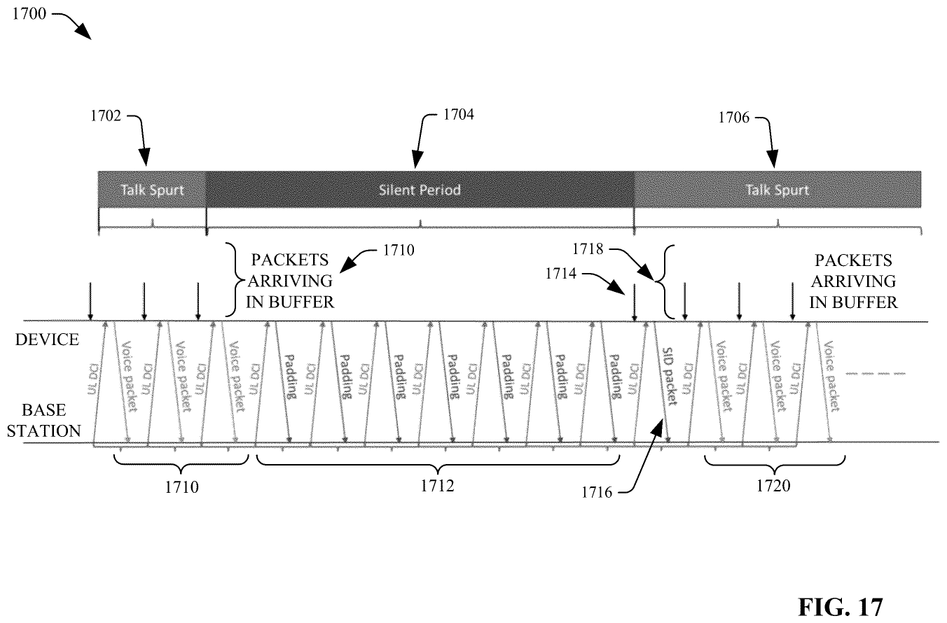

Referring briefly to FIG. 17, FIG. 17 depicts a diagram of an example traffic pattern 1700 for periodic uplink grants, with a desired periodicity, for the voice service. The example traffic pattern 1700 can comprise a talk spurt state 1702, followed by a silent period 1704, followed by another talk spurt state 1706. With the periodic uplink grant, the base station (e.g., the DU of the base station) can periodically provide (e.g., communicate) an uplink grant by sending time and frequency domain allocation to the device via DCI. Once the device receives the uplink grant, the device can send the uplink data to the base station during the slot (e.g., time slot) associated with the uplink grant.

During the talk spurt state 1702, the voice packets can arrive (e.g., can be stored in) the buffer (e.g., device MAC buffer) of the device, as indicated at reference numeral 1708, and the device can periodically communicate the voice packets (e.g., obtained from the buffer) to the base station, in accordance with (e.g., respectively after) the periodically uplink grants, received via DCI from the base station, as indicated at reference numeral 1710. In some existing techniques, during the silent period 1704, since the device is not communicating voice packets to the base station, but is receiving periodic uplink grants in accordance with the periodic uplink grant scheduling, the device can periodically communicate padding (e.g., padding packets), which can comprise no user data (e.g., no voice data or other user data), to the base station at each uplink grant slot (e.g., uplink grant time slot), as indicated at reference numeral 1712. Periodically during the silent period 1704, such as each SID frame duration period, the device can insert a silent frame 1714 in the buffer, and can communicate the silent frame, instead of padding, to the base station, in accordance with a corresponding periodic uplink grant (e.g., received by the device via uplink (UL) DCI)), as indicated at reference numeral 1716. If the silent period 1704 ends thereafter and changes to the next talk spurt state 1706 (as depicted), the silent period 1704 can end, and during the next talk spurt state 1706, the device can have voice packets arrive in the buffer, as indicated at reference numeral 1718, and the device can periodically communicate those voice packets to the base station during each uplink grant slot, in accordance with the periodic uplink grants, as indicated at reference numeral 1720. If, instead, the silent period 1704 continues after the silent frame (e.g., 1716), the device can again communicate padding to the base station during each uplink grant slot (e.g., in accordance with the periodic uplink grants), if and until the device communicates another silent frame, in an uplink grant slot, to the base station at the end of the SID frame duration period (e.g., for one or more SID frame duration periods), or if and until the device transitions back to the talk spurt state 1706, or if and until the communication session ends.

During the silent period (whether with regard to a configured grant or periodic uplink grants), voice packets are not generated by the device. During this silent period, the voice codec of the device can periodically communicate an SID frame (e.g., an SID packet) containing background noise (e.g., comfort noise). For an adaptive multirate (AMR) codec, the AMR codec can communicate an SID frame every 8th speech frame (e.g., every 8th slot) during the silent period (e.g., one SID frame every 160 ms), in accordance with an applicable protocol. For an enhanced voice services (EVS) codec, the SID frame duration can be fixed, variable, or adaptive. With the EVS codec, the default SID frame duration can be 8 frames (e.g., 160 ms), the variable SID frame duration can range from 3 to 100 frames (e.g., 60 ms to 2000 ms), and the adaptive SID frame duration can range from 8 to 50 frames (e.g., 160 ms to 1000 ms), in accordance with an applicable protocol. With existing techniques, the base station typically may not be aware of the codec type (e.g., AMR codec, EVS codec, or other type of codec) or the codec mode (e.g., fixed, variable, or adaptive modes), and, as a result, the base station cannot assume or determine a duration of the SID frame (e.g., the SID frame duration period).

As disclosed, during the silent period, voice packets are not generated by the device. As a result, during the silent period, the uplink resources allocated for voice packets will not be used by the device. For instance, in the case when the device does not have uplink voice-related data (e.g., voice-related data packets or SID frames) for a data radio bearer (DRB) associated with the service and the device, or even uplink data for other DRBs associated with the device, the device can send padding (e.g., padding packets) to the base station using the allocated uplink grant slots and resources, which can lead to undesired wastage of air interface resources and/or other resources of the communication network (e.g., the base station of the communication network). As a result, the existing techniques and mechanisms of uplink scheduling for voice services of devices can be undesirably deficient, as they can result in undesired wastage of air interface resources and/or other resources of the communication network, and undesirable (e.g., unwanted, inefficient, unacceptable, or suboptimal) performance of the device and communication network.

The disclosed subject matter can address and overcome these and other deficiencies and challenges of the existing techniques and mechanisms with regard to utilization of services, such as voice services (e.g., where silent periods can be employed). In that regard, it can be desirable (e.g., wanted, useful, efficient, advantageous, or optimal) to have a base station (e.g., a DU of a base station) be able to learn and determine (e.g., adaptively and/or continuously learn and determine) an SID frame duration of communication of SID frames by a device during a communication session of the device, and mitigate (e.g., reduce or minimize) wastage of uplink air interface resources and/or other resources by bypassing (e.g., skipping or omitting) certain uplink grant allocation, and certain associated uplink grant slots, during the silent period and/or bypassing certain configured grant slots during the silent period. Also, it can be desirable to use those certain uplink grant allocations and associated uplink grant slots, and/or those certain configured grant slots, during the silent period, to schedule uplink grants and/or allocate other resources to other devices.

The disclosed subject matter can employ enhanced SID frame duration learning and determination techniques that can enable a base station to be able to adaptively and/or continuously learn and determine an SID frame duration of communication of SID frames by a device during a communication session of the device, and mitigate (e.g., reduce or minimize) wastage of uplink air interface resources and/or other resources by bypassing certain uplink grant allocation, and certain associated uplink grant slots, during the silent period and/or bypassing certain configured grant slots during the silent period. Also, enhanced SID frame duration learning and determination techniques employed by the base station can enable the base station to utilize those certain uplink grant allocations and associated uplink grant slots, and/or those certain configured grant slots, during the silent period, to schedule uplink grants and/or allocate other resources to other devices. To that end, techniques that can desirably (e.g., automatically, dynamically, suitably, reliably, efficiently, enhancedly, and/or optimally) learn and determine (e.g., adaptively and/or continuously learn and determine) an SID frame duration of communication of SID frames by a device during a silent period of a communication session of the device, control bypassing of periodic uplink grants or configured grant slots during the silent period (e.g., based at least in part on the SID frame duration), and mitigate wastage of uplink air interface resources and/or other resources of the device or a communication network, are presented. A system can comprise a communication network that can comprise a core network and one or more RANs that can be associated with (e.g., communicatively connected to) the core network. A RAN can comprise one or more base stations, wherein a base station can be associated with (e.g., wirelessly communicatively connected to) a device with regard to a communication session where the device can be utilizing a desired service (e.g., a voice service or other type of service) of or associated with the communication network.

The device can be utilizing a service, such as, for example, a voice-related service (e.g., VoNR service or other desired voice-related service), wherein a communication session can be established with the service via the base station. During the communication session, the communication session and device can transition between various states, such as a talk spurt period (e.g., talk spurt state) and a silent period (e.g., silent state). The talk spurt period can be a period where the device can be communicating voice-related data packets, in slots (e.g., uplink grant time slots), in accordance with periodic uplink grants or a configured grant. The silent period can be a period where the device can be communicating (e.g., periodically communicating) SID frames or communicating padding (e.g., in between the SID frames), in slots, in accordance with the periodic uplink grants or the configured grant.

In accordance with various embodiments, the base station can comprise an uplink communication manager component that can determine or detect when the communication session is in the silent period based at least in part on a silent period detection threshold value (e.g., a threshold number of consecutive slots without a voice-related data packet or SID frame being received from the device by the base station). When the communication session (and the device) is determined to be in the silent period, the uplink communication manager component can learn, detect, and/or determine an SID frame duration between the communication of SID frames by the device, during the silent period of the communication session, based at least in part on a determination of a number of consecutive slots without an uplink voice-related data packet or an SID frame (e.g., a number of consecutive slots without a voice-related protocol data unit (PDU)) being received from the device during the silent period. For example, the uplink communication manager component can learn, detect, and/or determine an SID frame duration between the communication of SID frames by the device, during the silent period of the communication session, based at least in part on a determination of the number of consecutive slots (e.g., inclusive of the slot wherein the SID frame was received) between a most recent (e.g., a previous) uplink voice-related data packet being received from the device (e.g., at the end of the most recent talk spurt period) and the SID frame being received, during the silent period, from the device.

During the current silent period and/or a next silent period(s) of the communication session, the uplink communication manager component can initiate bypassing of at least the one uplink grant slot, for a defined time period (e.g., a defined number of slots or a defined number of configured grant slots), during the silent period of the communication session, wherein the defined time period can be determined (e.g., by the uplink communication manager component) based at least in part on the SID frame duration. For instance, if the uplink grants are periodic uplink grants, the uplink communication manager component can determine (e.g., calculate) a defined number of slots for which at least the one periodic uplink grant slot is to be bypassed as a function of the SID frame duration, the threshold number of consecutive slots relating to the silent period (e.g., the silent period detection threshold value), and a periodic uplink grant period of the periodic uplink grants associated with the communication session, such as described herein. The uplink communication manager component can control communication of periodic uplink grants to not communicate any periodic uplink grants to the device during or for the defined number of slots during the silent period (e.g., during a portion of the silent period between the communication of SID frames by the device). As a result of not receiving uplink grants for the defined number of slots, the device can bypass communicating, or can otherwise not communicate, data (e.g., padding) for the defined number of slots during that portion of the silent period. Given the determined SID frame duration, after the defined number of slots, the base station can expect a next SID frame, if the silent period is to continue, or a next voice-related data packet, if the communication session is transitioning from the silent period to the next talk spurt state. The uplink communication manager component can similarly control bypassing of periodic uplink grants for other respective defined numbers of slots during another portion(s) (if any) of that silent period or another silent period(s) (if any) of the communication session.

With regard to when a configured grant is employed for the communication session, the uplink communication manager component can determine (e.g., calculate) a defined number of configured grant slots that can be bypassed during the communication session (e.g., during a portion of the silent period of the communication session) as a function of the SID frame duration, the threshold number of consecutive slots relating to the silent period (e.g., the silent period detection threshold value), and a configured grant periodicity of the configured grant, such as described herein. The uplink communication manager component can initiate and control bypassing of the defined number of configured grant slots by communicating DCI to the device, wherein the DCI can instruct or inform the device to bypass the defined number of configured grant slots during the silent period (e.g., during a portion of the silent period between the communication of SID frames by the device). Based at least in part on the DCI, the device can reconfigure the configured grant to bypass the defined number of configured grant slots during the silent period (e.g., the portion of the silent period). As a result of such bypassing, the device can bypass communicating, or can otherwise not communicate, data (e.g., padding) for the defined number of configured grant slots. Given the determined SID frame duration, after the defined number of configured grant slots, the base station can expect a next SID frame, if the silent period is to continue, or a next voice-related data packet, if the communication session is transitioning from the silent period to the next talk spurt state. The uplink communication manager component can similarly control bypassing of configured grant slots for other respective defined numbers of configured slots during another portion(s) (if any) of that silent period or another silent period(s) (if any) of the communication session.

The uplink communication manager component can continue to monitor the communication of data during the communication session to facilitate determining whether the communication session and device transition from one state to another state (e.g., transition from a talk spurt period to a silent period, or vice versa), learning, determining, and/or detecting any change (e.g., modification) to the SID frame duration (if any such change occurs), and/or controlling bypassing of uplink grants (e.g., periodic uplink grants, or a portion of a configured grant) or associated uplink grant slots (e.g., periodic uplink grant slots or configured grant slots).

The disclosed subject matter, by employing the uplink communication manager component and the techniques described herein, can desirably (e.g., suitably, efficiently, enhancedly, or optimally) mitigate (e.g., reduce or minimize) wastage of uplink air interface resources and/or other resources of the device and/or the communication network (e.g., the base station or other network component(s) of the communication network) by bypassing (e.g., skipping or omitting) certain uplink grant allocation, and certain associated uplink grant slots (e.g., certain periodic uplink grant slots or configured grant slots), during the silent period(s) of the communication session, as compared to existing techniques that can involve undesirable (e.g., unwanted, unnecessary, and/or suboptimal) wastage of uplink air interface resources and/or other resources of the device and/or the communication network, and undesirable (e.g., unwanted, unnecessary, and/or suboptimal) communication of padding (e.g., padding packets) by the device and processing of such padding by the base station, during a silent period(s) of a communication session. Also, the disclosed subject matter, by employing the uplink communication manager component and the techniques described herein, can desirably (e.g., suitably, efficiently, enhancedly, or optimally) utilize (e.g., allocate or assign) those certain uplink grant allocations and certain associated uplink grant slots (e.g., certain periodic uplink grant slots or configured grant slots that were bypassed during the silent period(s) of the communication session of the device), and resources associated therewith (e.g., resources that were not utilized as a result of such bypassing), to schedule uplink grants and/or allocate other resources to another device(s) during another communication session(s) of the other device(s). Further, the disclosed subject matter, by employing the uplink communication manager component and the techniques described herein, can desirably (e.g., suitably, efficiently, enhancedly, or optimally) reduce the amount of power utilized by the device and/or the amount of power utilized by the communication network (e.g., the base station and/or other network component of the communication network) during the communication session, as compared to the amount of power that would be used by another device or the communication network during a communication session using existing techniques.

These and other aspects and embodiments of the disclosed subject matter will now be described with respect to the drawings.

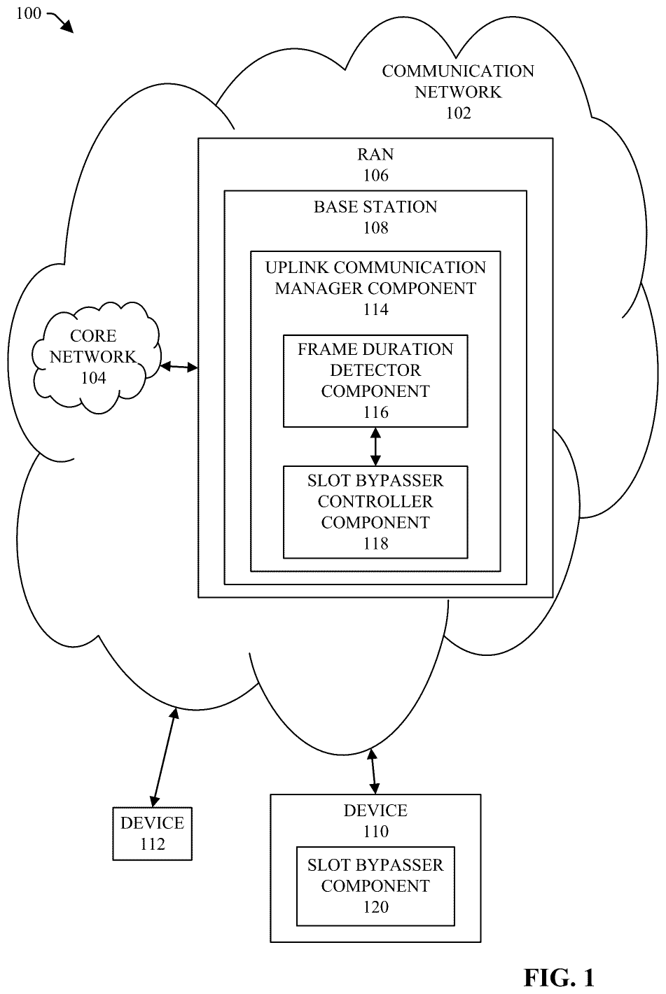

Referring now to the drawings, FIG. 1 illustrates a block diagram of a non-limiting example system 100 that can desirably (e.g., automatically, dynamically, suitably, reliably, efficiently, enhancedly, and/or optimally) learn and determine (e.g., adaptively and/or continuously learn and determine) an SID frame duration of communication of SID frames by a device during a communication session of the device, control bypassing of certain uplink grant slots during a silent period(s) of the communication session (e.g., based at least in part on the SID frame duration), and mitigate wastage of uplink air interface resources and/or other resources of the device or a communication network, in accordance with various aspects and embodiments of the disclosed subject matter. The system 100 can comprise a communication network 102 that can comprise a core network 104 and one or more RANs, such as RAN 106, that can be associated with (e.g., communicatively connected to) the core network 104. Each RAN (e.g., RAN 106) can comprise one or more base stations, such as, for example, base station 108, that each can comprise one or more cells (not shown).

The core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108) can be a 5G or other NR base station (e.g., gNB or other NR-type or xG base station, wherein x can be a number greater than 5). In certain embodiments, the core network 104 can comprise a UPF node, an access and mobility management function (AMF) node, and/or other network functions (not shown in FIG. 1 for reasons of brevity and clarity). The UPF node can connect to or interface with the one or more RANs (e.g., RAN 106) and the one or more base stations (e.g., base station 108), can be an interconnect point between the core network 104 and a data network (DN), can provide or facilitate providing a PDU session anchor point for providing mobility associated with radio access technologies (RATs), can provide or facilitate providing data packet routing or forwarding, and/or can perform or manage other functions. The AMF node can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) (e.g., base station 108) can be a fourth generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services. The services can comprise or relate to, for example, voice service (e.g., conversational voice services or other voice services, such as VoNR services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service.

When a device is utilizing certain services, such as, for example a voice-related service (e.g., VoNR or other voice-related service), there can be certain periods where the device 110 can be communicating service-related data packets (e.g., voice-related data packets) in uplink grant slots and other periods where the device can be communicating padding (e.g., padding or non-service-related packets, such as packets that do not include voice-related data, such as voice-related PDU) and periodically communicating SID frame packets in uplink grant slots. For instance, with regard to a voice-related service, during a talk spurt period of a communication session, the device can be communicating voice-related data packets in uplink grant slots to the base station, and during a silent period of the communication session, the device can be communicating padding packets and periodically communicating SID frame packets in uplink grant slots to the base station, wherein the SID frame packets can be a form of voice-related data packet as well. As disclosed, with some existing techniques relating to provision of services, such as voice-related services, the base station typically may not know when the device (and the communication session) is in the silent period, and may not know how long the SID frame duration is (e.g., how long the SID frame duration is between an SID frame packet and a next SID frame packet) in the silent period), as the codecs employed by the device during the communication session can be fixed, variable, or adaptive, depending on the type of codec.

As a result, with some existing techniques for provision of such services, during the silent period, since the device is not communicating voice-related data packets, except for periodic SID frame packets, and is instead communicating padding packets, in many of the uplink grant slots, to the base station, a significant amount of the uplink resources (e.g., uplink grant slots and other resources) allocated for voice-related data packets will not be used during the silent period by the device. For instance, in the case when the device does not have uplink voice-related data (e.g., voice packets or SID frames) for a DRB associated with the service and the device, or even uplink data for other DRBs associated with the device, the device can end up sending padding (e.g., padding packets), instead of voice-related data packets associated with the service, to the base station using the allocated uplink grant slots and resources. This can lead to undesired (e.g., unwanted, inefficient, unacceptable, or suboptimal) wastage of air interface resources and/or other resources of the communication network (e.g., the base station and/or other network component of the communication network). Consequently, existing techniques and mechanisms of uplink scheduling for voice-related services for devices can be undesirably deficient, as they can result in undesired wastage of air interface resources and/or other resources of the communication network, and undesirable (e.g., unwanted, inefficient, unacceptable, or suboptimal) performance of the device and communication network.

The disclosed subject matter can overcome these deficiencies and other problems of existing techniques. To that end, in accordance with various embodiments, the system 100 can comprise an uplink communication manager component 114 that can desirably (e.g., automatically, dynamically, suitably, reliably, efficiently, enhancedly, and/or optimally) detect or determine when a device (e.g., device 110), utilizing a service (e.g., voice-related service), is in a silent period of a communication session associated with the device, learn and determine (e.g., adaptively and/or continuously learn and determine) an SID frame duration of communication of SID frames by the device during the silent period of the communication session, determine slots (e.g., periodic uplink grant slots or configured grant slots) that can be bypassed during the silent period based at least in part on the SID frame duration, bypass or facilitate bypassing periodic uplink grants for periodic uplink grant slots or bypassing configured grant slots, and mitigate wastage of uplink air interface resources and/or other resources of the communication network 102 and/or the device, in accordance with the defined communication management criteria. In some embodiments, the uplink communication manager component 114 can be part of the base station 108 (e.g., a distributed unit (DU) of the base station 108), such as described herein. In other embodiments, the uplink communication manager component 114 can be a standalone component or part of another component, such as a controller (e.g., a RAN intelligent controller (RIC) or other type of controller), associated with the RAN(s) 106), and/or can be located or situated elsewhere in or associated with the communication network 102, wherein the uplink communication manager component 114 can be associated with (e.g., communicatively connected to) the base station 108 and/or RAN 106.

At a desired time, the device 110 can be utilizing a service (e.g., voice-related service) and can establish a communication session with the service via the base station 108. In some embodiments, the uplink communication manager component 114 can comprise a frame duration detector component 116 that can determine or detect when the communication session associated with the device 110 is in a silent period (e.g., has transitioned from the talk spurt period to the silent period) based at least in part on a tracking of data packets received from the device 110 by the base station 108 and a silent period detection threshold value (e.g., a threshold number of consecutive slots without a voice-related data packet or SID frame being received from the device 110 by the base station 108). When the frame duration detector component 116 determines that the communication session is in the silent period, the frame duration detector component 116 can continue the monitoring and tracking of data packets received from the device 110 by the base station 108. Based at least in part on such monitoring and tracking (e.g., tracking and analysis) of data packets, the frame duration detector component 116 can learn, detect, and/or determine an SID frame duration for the silent period (e.g., silent period 304). In some embodiments, the SID frame duration can be expressed as a number of slots between receiving a voice-related data packet (e.g., last voice-related data packet of a talk spurt period) and an SID frame (e.g., first SID frame of the silent period that occurs immediately after the talk spurt period), or a number of slots between receiving an SID frame and a next SID frame during the silent period, from the device 110 (e.g., using a codec). Typically, during a communication session associated with a device, the number of slots between receiving the SID frame and the next SID frame during the silent period can be the same as the number of slots between receiving the last voice-related data packet of the talk spurt period and the first SID frame of the silent period, although there may be instances where the SID frame duration can change (which can be detected by the frame duration detector component 116, if such a change does happen to occur). In certain embodiments, the frame duration detector component 116 can determine the SID frame duration based at least in part on a number of consecutive slots without a voice-related data packet or SID frame being received from the device 110 by the base station 108 (e.g., a number of consecutive slots between receiving, from the device 110, a last voice-related data packet of a talk spurt period and a first SID frame packet of the silent period occurring immediately after the talk spurt period).

With the frame duration detector component 116 having learning the SID frame duration, the uplink communication manager component 114, employing a slot bypasser controller component 118, desirably can control uplink grant scheduling for the device 110, comprising controlling bypassing of certain uplink grant slots (e.g., certain periodic uplink grant slots or configured grant slots) between the communication of SID frame packets to the base station 108 by the device 110 during the silent period and/or a next silent period(s) of the communication session. For instance, if the uplink grants are periodic uplink grants, the slot bypasser controller component 118 can determine a defined number of slots for which periodic uplink grants (e.g., one or more periodic uplink grants) for the device 110 are to be bypassed based at least in part on (e.g., as a function of) the SID frame duration, the silent period detection threshold value, and a periodic uplink grant period of the periodic uplink grants associated with the communication session. In certain embodiments, the slot bypasser controller component 118 can determine (e.g., calculate) the defined number of slots for which the periodic uplink grants for the device 110 are to be bypassed as being equal to: SID frame duration (e.g., expressed as the number of slots between an SID frame packet and the next SID frame packet)—silent period detection threshold value (e.g., expressed as the threshold number of consecutive slots indicative of the silent period)—periodic uplink grant period (e.g., expressed as the number of slots between a periodic uplink grant and a next periodic uplink grant).

The slot bypasser controller component 118 can control communication of periodic uplink grants to the device 110 to not communicate any periodic uplink grants to the device 110 during or for the defined number of slots during the silent period (e.g., during a portion of the silent period between the communication of SID frames by the device 110), such as described herein. As a result of not receiving uplink grants for the defined number of slots during the silent period, the device 110 can bypass communicating, or can otherwise not communicate, data (e.g., padding) for the defined number of slots during that portion of the silent period. Given the determined SID frame duration, after the defined number of slots, the base station 108 can expect a next SID frame from the device 110, if the silent period is to continue, or a next voice-related data packet from the device 110, if the communication session is transitioning from the silent period to the next talk spurt period, which can be monitored and tracked by the uplink communication manager component 114. The slot bypasser controller component 118 can similarly control bypassing of periodic uplink grants for other respective defined numbers of slots during another portion(s) (if any) of that silent period or another silent period(s) (if any) of the communication session.

If a configured grant is employed for the communication session associated with the device 110, the slot bypasser controller component 118 can determine a defined number of configured grant slots for the device 110 that can be bypassed during the communication session (e.g., during a portion of the silent period of the communication session) based at least in part on (e.g., as a function of) the SID frame duration, the silent period detection threshold value, and a configured grant periodicity of the configured grant. In some embodiments, the slot bypasser controller component 118 can determine (e.g., calculate) the defined number of configured grant slots for the device 110 that can be bypassed during the communication session (e.g., during a portion of the silent period of the communication session) as being equal to: ((SID frame duration-silent period detection threshold value)/configured grant periodicity)−1), wherein the configured grant periodicity can be expressed as the number of slots between a configured grant slot and a next configured grant slot.

The slot bypasser controller component 118 can initiate and control configured grant scheduling for the device 110, comprising initiating and controlling bypassing of the defined number of configured grant slots, by communicating DCI to the device 110, wherein the DCI can instruct or inform the device 110 to bypass the defined number of configured grant slots during the silent period (e.g., during a portion of the silent period between the communication of SID frames by the device 110). Based at least in part on the DCI, the device 110, employing a slot bypasser component 120, can reconfigure the configured grant to bypass the defined number of configured grant slots during the silent period (e.g., the portion of the silent period between the communication of SID frames by the device 110). As a result of such bypassing, the device 110 can bypass communicating, or can otherwise not communicate, data (e.g., padding) for the defined number of configured grant slots during the portion of the silent period. Given the determined SID frame duration, after the defined number of configured grant slots, the base station 108 can expect a next SID frame from the device 110, if the silent period is to continue, or a next voice-related data packet from the device 110, if the communication session is transitioning from the silent period to the next talk spurt period. The slot bypasser controller component 118 can similarly control bypassing of configured grant slots for other respective defined numbers of configured slots during another portion(s) (if any) of that silent period or another silent period(s) (if any) of the communication session associated with the device 110.

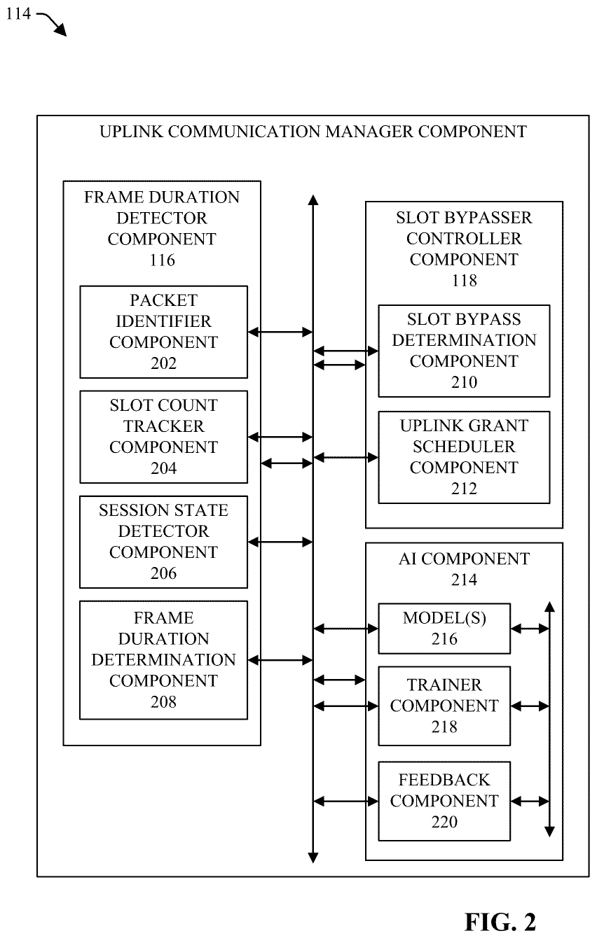

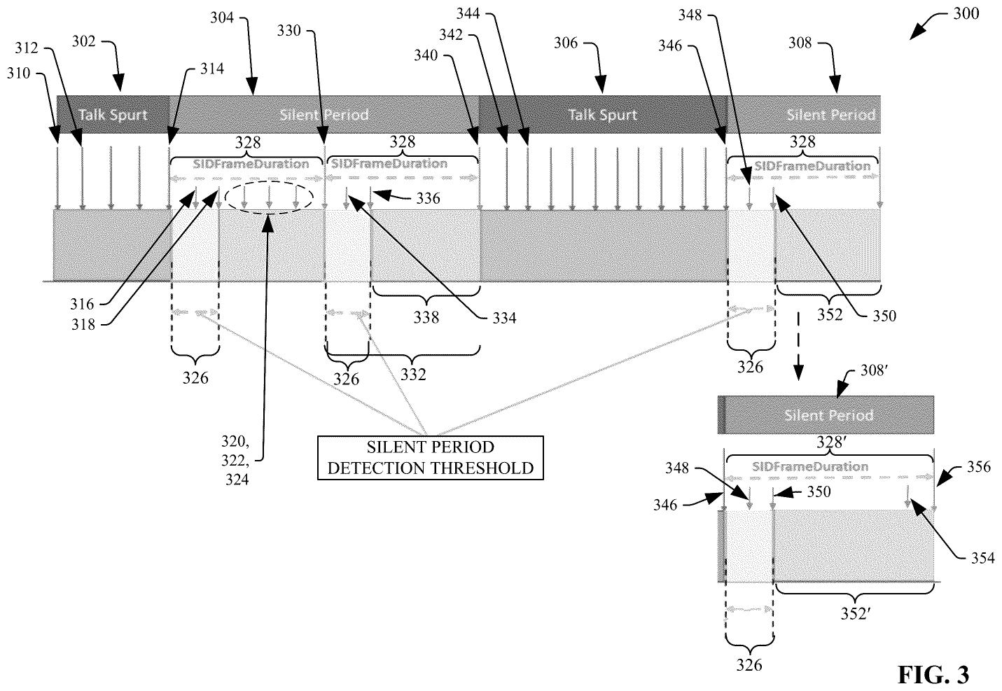

Referring to FIGS. 2 and 3 (along with FIG. 1), FIG. 2 depicts a block diagram of a non-limiting example uplink communication manager component 114, and FIG. 3 illustrates a block diagram of a non-limiting example communication session 300 associated with a device (e.g., device 110) and comprising talk spurt periods and silent periods, in accordance with various aspects and embodiments of the disclosed subject matter.

The uplink communication manager component 114 can comprise the frame duration detector component 116 and the slot bypasser controller component 118, such as described herein. In accordance with various embodiments, the frame duration detector component 116 can comprise or be associated with a packet identifier component 202, a slot count tracker component 204, a session state detector component 206, and a frame duration determination component 208, such as described herein. In accordance with various embodiments, the slot bypasser controller component 118 can comprise or be associated with a slot bypass determination component 210 and an uplink grant scheduler component 212, such as described herein.

The example communication session 300 can comprise a talk spurt period 302, a silent period 304 that can occur after the talk spurt period 302, a talk spurt period 306 that can occur after the silent period 304, and a silent period 308 that can occur after the talk spurt period 306. During the talk spurt period 302, the device 110 can be communicating voice-related data packets, comprising voice-related data packets 310, 312, and 314, in uplink grant slots, in accordance with an uplink grant schedule, which can be based on periodic uplink grants or a configured grant.

During the communication session 300, the uplink communication manager component 114 can be monitoring and tracking data packets being received by the base station 108 from the device 110. The packet identifier component 202 can identify, determine, and/or distinguish between voice-related data packets and padding packets, based at least in part on the results of analyzing the information of or associated with the received data packets. The voice-related data packets can comprise voice-related PDUs, whereas padding packets may not include voice-related PDUs. With at least some of the voice-related data packets, such as voice-related data packets during a talk spurt period (e.g., 302), the voice-related PDUs can comprise voice (e.g., voice of a user of the device 110) or other audio information of the communication session. An SID frame packet, which can be communicated during a silent period (e.g., 304) of the communication session 300, can be another type of voice-related data packet that can comprise a voice-related PDU, where the audio information of the voice-related PDU can merely be noise (e.g., comfort noise). In some embodiments, the packet identifier component 202 can identify or determine whether a data packet is a voice-related data packet (e.g., voice-related data packet or SID frame packet) or a padding packet, based at least in part on whether the analysis results of analyzing such data packet indicate that the data packet comprises a voice-related PDU or does not contain a voice-related PDU.

During the talk spurt period 302, the packet identifier component 202 can identify or determine that the data packets are voice-related data packets (e.g., 310, 312, 314), based at least in part on the results of analyzing those data packets. During the silent period 304 (which the base station 108 does not have prior knowledge that the communication session 300 is transitioning from the talk spurt period 302 to the silent period 304), the packet identifier component 202 can identify or determine that a group of data packets (e.g., data packets 316, 318, 320, 322, and 324) received after voice-related data packet 314 can be padding packets, based at least in part on the results of analyzing those data packets (e.g., data packets 316, 318, 320, 322, and 324).

As the data packets are received by the base station 108, and analyzed and identified by the packet identifier component 202, the session state detector component 206 can monitor and track the data packet types of the data packets to facilitate detecting or determining whether the communication session 300 has transitioned from a first state (e.g., talk spurt period 302) to a second state (e.g., silent period 304). For instance, as the voice-related data packets (e.g., 310, 312, 314) are received and identified, the session state detector component 206 can determine that the communication session 300 (and associated device 110) is in the talk spurt period 302. When the data packet 316 is received by the base station 108 and identified as a padding packet by the packet identifier component 202, the session state detector component 206 can initiate tracking of the number of consecutive slots, as part of the communication session 300, without receiving a voice-related data packet or SID frame packet. The session state detector component 206 can operate in conjunction with the slot count tracker component 204 to track the number of consecutive slots without the base station 108 receiving a voice-related data packet or SID frame packet, as part of the communication session 300. The slot count value initially can be set to a desired default value (e.g., 0 or other desired default value). The slot count value can be utilized to facilitate determining whether the silent period detection threshold value is satisfied, and/or tracking and determining the SID slot frame duration. The initial value of the SID slot frame duration also can be a desired default value (e.g., 0 or other desired default value), as the initial slot count value also can act as the initial value of the SID slot frame duration.

For example, if and as slots (e.g., time slots) associated with the communication session 300 continue without the base station 108 receiving a voice-related data packet or SID frame packet from the device 110, the slot count tracker component 204 can increment (e.g., by 1, or other desired amount) a slot count value from a default (or reset) slot count value (e.g., 0) to a next value (e.g., 1), to a next value (e.g., 2), to a next value (e.g., 3), and so on. If, in this example scenario of the communication session 300, the periodicity of uplink grants, and accordingly, uplink grant slots, is 40 slots, the base station 108 can receive, or at least can expect to receive, a data packet from the device 110 every 40 slots. As a result, when the data packet 316 is received in an uplink grant slot by the base station 108 and is identified as a padding packet, the slot count tracker component 204 can increment (e.g., by 1, or other desired amount) the slot count value from the current slot count value (e.g., 39) to a next value (e.g., 40). The session state detector component 206 can analyze (e.g., compare) the slot count value in relation to (e.g., as compared to) the silent period detection threshold value (e.g., the threshold number of consecutive slots indicative of the silent period) of the silent period detection threshold 326 to determine whether the slot count value satisfies (e.g., meets, equals, or otherwise satisfies) the silent period detection threshold value to determine whether the communication session 300 has transitioned from the talk spurt period 302 to the silent period 304. In some embodiments, the silent period detection threshold value can be 80 slots (e.g., 80 consecutive slots without the base station 108 receiving a voice-related data packet or SID frame packet from the device 110), although, in other embodiments, the silent period detection threshold value can be less than or greater than 80 slots, as desired, in accordance with (e.g., as specified by) the defined communication management criteria. For instance, a voice-related silent period detection threshold can be 2 (e.g., 2 uplink grants, or 2 configured grant slots), and a voice-related frame duration can be 40 slots, wherein the silent period detection threshold value can be equal to the voice-related silent period detection threshold multiplied by the voice-related frame duration, which can be 80 slots (e.g., 2*40 slots=80 slots). In this example scenario, with the silent period detection threshold value being 80 slots, and with the slot count value being at 40, the session state detector component 206 can determine that the slot count value is less than the silent period detection threshold value, and, as a result, can determine that the silent period detection threshold value has not been satisfied, and can further determine that the tracking of data packets is to continue and no determination regarding a change of communication session state can be made (e.g., at least at this time).

When the next data packet 318 is received in the next uplink grant slot by the base station 108 and is identified as a padding packet, the slot count tracker component 204 can increment (e.g., by 1, or other desired amount) a slot count value from the current slot count value (e.g., 79) to a next value (e.g., 80). The session state detector component 206 can analyze the slot count value (e.g., 80) in relation to the silent period detection threshold value (e.g., 80 slots). Based at least in part on the results of such analysis, the session state detector component 206 can determine that the slot count value satisfies the silent period detection threshold value, and, as a further result, can determine that the communication session 300 has transitioned from the talk spurt period 302 to the silent period 304.

With the communication session 300 determined to be in the silent period 304, as other data packets (e.g., data packets 320, 322, and 324, and other data packets thereafter) are received by the base station 108 and identified by the packet identifier component 202, the slot count tracker component 204 can continue to track the number of consecutive slots without the base station 108 receiving a voice-related data packet or SID frame packet, as part of the communication session 300. The frame duration determination component 208 can utilize the slot count value to determine the SID frame duration 328, which can be the number of consecutive slots between the base station 108 receiving a voice-related data packet and an SID frame packet from the device 110, or the number of consecutive slots between the base station 108 receiving an SID frame packet and a next SID frame packet from the device 110, as part of the communication session 300 (e.g., which typically can be the same value as the number of consecutive slots between the base station 108 receiving a voice-related data packet and an SID frame packet from the device 110).

For instance, in this example scenario of the communication session 300, since the packet identifier component 202 can identify the data packets 320, 322, and 324 as padding packets received in respective uplink grants slots with a periodicity of 40 slots, the slot count tracker component 204 can increment the slot count value 120 more times (e.g., to a slot count value of 200) in connection with those uplink grant slots and the other slots in between or surrounding those uplink grant slots. When the base station 108 receives data packet 330 from the device 110, the packet identifier component 202 can identify or determine the data packet 330 to be a voice-related data packet based at least in part on the results of analyzing the data packet 330, and can determine or assume that this voice-related data packet can be an SID frame packet (e.g., since the communication session 300 is in the silent period 304). In some embodiments, the slot count tracker component 204 can increment the slot count value from the current slot count value (e.g., 239) to a next value (e.g., 240) to account for the uplink slot in which the current data packet 330 (e.g., the SID frame packet or voice-related data packet) was received. In this example scenario, the slot count value can be at 240 slots, which can be the number of consecutive slots (e.g., inclusive of the slot in which the SID frame packet 330 was received) between the receiving of voice-related data packet 314 and SID frame packet 330, without another voice-related data packet being received in between the voice-related data packet 314 and the SID frame packet 330. Accordingly, the frame duration determination component 208 can determine the SID frame duration 328 as function of (e.g., as being equal to) the number of consecutive slots (e.g., inclusive of the slot wherein the SID frame packet 330 was received) without the base station 108 receiving a voice-related data packet or an SID frame packet from the device 110 (e.g., the number of consecutive slots (e.g., inclusive of the slot wherein the SID frame packet 330 was received) between the base station 108 receiving a voice-related data packet and receiving the SID frame packet 330 from the device 110), as part of the communication session 300. In this example scenario, the frame duration determination component 208 can determine that the SID frame duration 328 is 240 slots, based at least in part on the slot count value of 240 indicating that there are 240 slots (e.g., inclusive of the slot wherein the SID frame packet 330 was received) between the base station 108 receiving a voice-related data packet and receiving the SID frame packet 330.

The frame duration detector component 116 can store this SID frame duration 328 in a data store, and can utilize this SID frame duration 328 to facilitate controlling bypassing of periodic uplink grants for a certain number of slots (if periodic uplink grants are employed) or bypassing configured grant slots (if a configured grant is employed) during the silent period(s) (e.g., silent period 304 and/or silent period 308), such as described herein. In some embodiments, in response to determining that the number of consecutive slots without receiving a voice-related data packet or an SID frame packet has ended, the slot count tracker component 204 can reset the slot count value back to the default (or reset) slot count value (e.g., 0), which also can reset the initial value of the SID slot frame duration back the desired default value (e.g., 0).

With the SID frame duration 328 determined, the slot bypasser controller component 118 can determine (e.g., calculate) a defined number of slots to bypass, for periodic uplink grants, or a defined number configured grant slots to bypass during a next portion(s) (e.g., a next SID frame duration period) of the silent period (e.g., silent period 304) and/or during one or more portions of a next silent period (e.g., silent period 308) of the communication session associated with the device 110. In some embodiments, the slot bypasser controller component 118 can comprise a slot bypass determination component 210 that can determine the defined number of slots to bypass, for periodic uplink grants, or the defined number configured grant slots, for a configured grant, to bypass during a next portion(s) of the silent period 304 or next silent period(s) 308 of the communication session 300 based at least in part on the SID frame duration 328. For instance, if the uplink grants are periodic uplink grants for the communication session 300, the slot bypass determination component 210 can determine (e.g., calculate) the defined number of slots for which periodic uplink grants can be bypassed as a function of the SID frame duration 328, the silent period detection threshold value, and the periodic uplink grant period. In this example scenario, the slot bypass determination component 210 can determine (e.g., calculate) the defined number of slots for which periodic uplink grants are to be bypassed as being: 240 slots-80 slots-40 slots=120 slots.

If, instead, a configured grant is employed for the communication session 300, the slot bypass determination component 210 can determine the defined number of configured grant slots that can be bypassed during the communication session 300 (e.g., during a portion of the silent period of the communication session 300) as a function of the SID frame duration, the silent period detection threshold value, and the configured grant periodicity. In this example scenario, the slot bypass determination component 210 can determine (e.g., calculate) the defined number of configured slots that can be bypassed as: ((240 slots-80 slots)/40 slots)−1=3.

During the next portion 332 of the silent period 304 (e.g., of what will be determined to be the next portion 332 of the silent period 304 by the uplink communication manager component 114), after the SID frame packet 330 has been received by the base station 108, the uplink communication manager component 114 can continue monitoring and tracking of data packets being received by the base station 108 from the device 110 during the communication session 300 to facilitate determining whether the communication session 300 continues to be in the silent period 304 or has transitioned to the next talk spurt period 306 (or has ended).

For instance, as the data packets 334 and 336 are received by the base station 108 from the device 110, the packet identifier component 202 can identify or determine that data packets 334 and 336 are padding packets, based at least in part on the results of an analysis of the data packets 334 and 336, such as described herein. The slot count tracker component 204 can track and increment the consecutive number of slots without receiving a voice-related data packet or SID frame packet, such as described herein. In this example scenario, after the padding packet 334 has been received from the device 110, the session state detector component 206 can analyze the slot count value in relation to the silent period detection threshold value to determine whether the slot count value (e.g., 40 slots, at this point in the example scenario) satisfies the silent period detection threshold value (e.g., 80 slots, in the example scenario) to facilitate determining whether the communication session 300 continues to be in the silent period 304 or has transitioned to the next talk spurt period 306. In this example scenario, with the silent period detection threshold value being 80 slots, and with the slot count value being at 40, the session state detector component 206 can determine that the slot count value is less than the silent period detection threshold value, and, as a result, can determine that the silent period detection threshold value has not (e.g., has not yet) been satisfied, and can further determine that the tracking of data packets is to continue and no determination regarding a change of communication session state can be made (e.g., at least at this time).

When the next data packet 336 is received in the next uplink grant slot from the device 110 by the base station 108 and is identified as a padding packet by the packet identifier component 202, the slot count tracker component 204 can increment (e.g., by 1, or other desired amount) a slot count value from the current slot count value (e.g., 79) to a next value (e.g., 80). The session state detector component 206 can analyze the slot count value (e.g., 80) in relation to the silent period detection threshold value (e.g., 80 slots). Based at least in part on the results of such analysis, the session state detector component 206 can determine that the slot count value satisfies the silent period detection threshold value, and, as a further result, can determine that the communication session 300 continues to be in the silent period 304.

With the determination that the communication session 300 continues to be in the silent period 304, the uplink communication manager component 114 can determine that certain periodic uplink grants or configured grant slots (whichever is applicable) can be bypassed. For instance, if periodic uplink grants are being employed in the communication session 300, the slot bypasser controller component 118, employing an uplink grant scheduler component 212, can control communication of periodic uplink grants to not communicate any periodic uplink grants to the device 110 during or for the defined number of slots (e.g., 120 slots, in this example scenario) during a remaining portion 338 (of the next portion 332) of the silent period 304. As a result of not receiving uplink grants for the defined number of slots during the remaining portion 338 of the silent period 304, the device 110 can bypass communicating, or can otherwise not communicate, data (e.g., padding packets) for the defined number of slots during that remaining portion 338 of the silent period 304.

If the configured grant is being employed in the communication session 300, the slot bypasser controller component 118, employing the uplink grant scheduler component 212, can initiate and control bypassing of the defined number of configured grant slots (e.g., 3 configured grant slots, in this example scenario) by communicating, to the device 110, DCI, that can instruct or inform the device 110 to bypass the defined number of configured grant slots during the remaining portion 338 of the silent period 304. Based at least in part on the DCI, the device 110, employing the slot bypasser component 120, can reconfigure the configured grant to bypass the defined number of configured grant slots during the remaining portion 338 of the silent period 304. As a result of such bypassing, the device 110 desirably can bypass communicating, or can otherwise not communicate, data (e.g., padding packets) for the defined number of configured grant slots.

As a further result of bypassing periodic uplink grants or configured grant slots during the remaining portion 338 of the silent period 304, wastage of resources of the communication network 102 (e.g., the base station 108 and/or other network component of the communication network 102) and/or the device 110 desirably can be mitigated (e.g., reduced or minimized). Also, as a further result, in some embodiments, those resources, which can be made available by not wasting them during this remaining portion 338 of the silent period 304 of the communication session 300, desirably can be utilized for one or more other communication sessions of one or more other devices (e.g., device 112) associated with the RAN 106.

As disclosed, the uplink communication manager component 114 can continue monitoring and tracking of data packets being received by the base station 108 from the device 110 during the communication session 300 to facilitate determining whether the communication session 300 continues to be in the silent period 304 or has transitioned to the next talk spurt period 306 (or has ended). In this example scenario, at the end of the SID frame duration 328 of the portion 332 of the silent period 304, the base station 108 can receive data packet 340, which the packet identifier component 202 can identify as an SID frame packet based at least in part on the results of analyzing the data packet 340. In this example scenario, the silent period 304 can be ending and the communication session 300 can be transitioning to the next talk spurt period 306 (e.g., as can be determined by the uplink communication manager component 114). It is to be appreciated and understood that, in other embodiments, instead of the data packet 340 being an SID frame packet, the data packet 340 can be a voice-related data packet comprising voice or other audio of the communication session 300, as opposed to the comfort noise of the SID frame packet. It also is to be appreciated and understood that, in some embodiments, if the data packet received, by the base station 108, at the end of the SID frame duration 438 of this remaining portion 338 of the silent period 304, or during any other silent period of the communication session 300, is not a voice-related data packet (e.g., a voice-related data packet or SID frame packet), but rather is determined to be a padding packet, the uplink communication manager component 114 can perform a new SID frame duration determination to adaptively learn and determine the new SID frame duration, as receiving a padding packet at the end of the SID frame duration, instead of a voice-related data packet, can indicate that the SID frame duration may have changed (e.g., for some reason).

With further regard to this example scenario, with the base station 108 having received the SID frame packet 340, the number of consecutive slots without receiving a voice-related data packet or an SID frame packet can be determined (e.g., by the uplink communication manager component 114) to have ended, and accordingly, the slot count tracker component 204 can reset the slot count value back to the default (or reset) slot count value (e.g., 0), which also can reset the initial value of the SID slot frame duration back the desired default value (e.g., 0). During the communication session 300, the base station 108 can continue to receive data packets, including data packets 342, 344, and 346 (and those data packets in between data packet 344 and data packet 346), and the packet identifier component 202 can determine that these data packets are voice-related data packets based at least in part on the results of analyzing those data packets (e.g., 342, 344, 346). With regard to receiving voice-related data packet 342 after having received SID frame packet 340 (or voice-related data packet), the session state detector component 206 can determine that the communication session 300 has transitioned from the silent period 304 to the talk spurt period 306. While in the talk spurt period 306, the slot bypasser controller component 118 can control uplink grant scheduling to not have any periodic uplink grants or configured grant slots bypassed during the talk spurt period 306. That is, the uplink communication manager component 114 can enable periodic uplink grants to the device 110 continue with the desired periodicity, if periodic uplink grants are employed, or, if the configured grant is employed, the device 110 can resume using configured grant slots, in accordance with the configured grant periodicity, during the talk spurt period 306.

After receiving voice-related data packet 346, the base station 108 can receive data packets 348 and 350, which the packet identifier component 202 can identify as padding packets based at least in part on the results of analyzing the data packet 340. In this example scenario, the talk spurt period 306 can be ending and the communication session 300 can be transitioning to the next silent period 308 (e.g., as can be determined by the uplink communication manager component 114). The slot count tracker component 204 can track and increment the number of consecutive slots without the base station 108 receiving a voice-related data packet or SID frame packet from the device 110 during the communication session 300, such as described herein. After padding packet 350 is received by the base station 108, the session state detector component 206 can determine that the communication session 300 has transitioned from the talk spurt period 306 to the silent period 308, based at least in part on determining that the number of consecutive slots without the base station 108 receiving a voice-related data packet or SID frame packet from the device 110 satisfies the silent period detection threshold value, such as described herein.

With the determination that the communication session 300 has transitioned from the talk spurt period 306 to the silent period 308, the uplink communication manager component 114 can determine that certain periodic uplink grants or configured grant slots (whichever is applicable) can be bypassed. For instance, if periodic uplink grants are being employed in the communication session 300, the slot bypasser controller component 118, employing an uplink grant scheduler component 212, can control communication of periodic uplink grants to not communicate any periodic uplink grants to the device 110 during or for the defined number of slots (e.g., 120 slots, in this example scenario) during a remaining portion 352 of the SID frame duration of the silent period 308 (or portion of the silent period 308). As a result of not receiving uplink grants for the defined number of slots during the remaining portion 352 of the SID frame duration of the silent period 308, the device 110 can bypass communicating, or can otherwise not communicate, data (e.g., padding packets) for the defined number of slots during that remaining portion 352 of the SID frame duration of the silent period 308. If, instead, the configured grant is being employed in the communication session 300, the slot bypasser controller component 118, employing the uplink grant scheduler component 212, can initiate and control bypassing of the defined number of configured grant slots (e.g., 3 configured grant slots, in this example scenario) by communicating, to the device 110, DCI, that can instruct or inform the device 110 to bypass the defined number of configured grant slots during the remaining portion 352 of the SID frame duration of the silent period 308. Based at least in part on the DCI, the device 110, employing the slot bypasser component 120, can reconfigure the configured grant to bypass the defined number of configured grant slots during the remaining portion 352 of the SID frame duration of the silent period 308. As a result of such bypassing, the device 110 desirably can bypass communicating, or can otherwise not communicate, data (e.g., padding packets) for the defined number of configured grant slots.

As a further result of bypassing periodic uplink grants or configured grant slots during the remaining portion 352 of the SID frame duration of the silent period 308, wastage of resources of the communication network 102 (e.g., the base station 108 and/or other network component of the communication network 102) and/or the device 110 desirably can be mitigated. Also, as a further result, in some embodiments, those resources, which can be made available by not wasting them during this remaining portion 352 of the SID frame duration of the silent period 308 of the communication session 300, desirably can be utilized for one or more other communication sessions of one or more other devices (e.g., device 112) associated with the RAN 106.

The uplink communication manager component 114 can continue to monitor the communication of data during the communication session 300 to facilitate determining whether the communication session and device transition from one state to another state (e.g., transition from a silent period to a talk spurt period, or vice versa), learning, determining, and/or detecting any change (e.g., modification) to the SID frame duration (if any such change occurs), and/or controlling bypassing periodic uplink grants for the defined number(s) of slots, if periodic uplink grants are employed, or bypassing the defined number of configured grant slots, if the configured grant is employed, during the silent period(s) of the communication session, in accordance with the defined communication management criteria. In some embodiments, if there is a change in the SID frame duration during the communication session, the uplink communication manager component 114 can detect the change in the SID frame duration, and can learn and adapt the SID frame duration to account for the change, and also can adapt (e.g., modify or adjust) the bypassing of periodic uplink grants for a certain number of slots or bypassing of configured grant slots based at least in part on the adapted SID frame duration. For example, in the example scenario of the communication session 300, if, instead of the silent period 308 having the same SID frame duration 328 as the other previous SID frame durations of the previous silent period 304, there is an alternative example scenario where there is a silent period 308′ having a longer SID frame duration 328′ than the other previous SID frame durations 328 of the previous silent period 304, the uplink communication manager component 114 can detect such change in the SID frame duration. For instance, like in the example scenario, after receiving padding packets 348 and 350, the session state detector component 206 can determine that the communication session 300 has transitioned from the talk spurt period 306 to the silent period 308, based at least in part on determining that the number of consecutive slots without the base station 108 receiving a voice-related data packet or SID frame packet from the device 110 satisfies the silent period detection threshold value, such as described herein. The slot bypasser controller component 118 can control bypassing of periodic uplink grants for the defined number of slots or bypassing of the defined number of configured grants slots, such as described herein.

The uplink communication manager component 114 can be expecting to receive an SID frame packet in the next uplink grant slot after the bypassing of periodic uplink grants for the defined number of slots or bypassing of the defined number of configured grants slots. However, since the SID frame duration 328′ for the silent period 308′ is longer than the previous SID frame durations 328 of the previous silent period 304 (and, accordingly, the remaining portion 352′ of the SID frame duration is longer), instead of receiving an SID frame packet in that uplink grant slot, the base station 108 can receive padding packet 354 from the device 110, wherein the packet identifier component 202 can identify that the padding packet 354 is a padding packet based at least in part on the results of analyzing such packet 354. At this point, the uplink communication manager component 114 can detect that there has been a change to the SID frame duration, since the base station 108 received a padding packet 354 in the uplink grant slot that was expected to have an SID frame packet based on the previous SID frame duration 328. In the next uplink grant slot, the base station 108 can receive SID frame packet 356 from the device 110, wherein the packet identifier component 202 can identify that the SID frame packet 356 is an SID frame packet based at least in part on the results of analyzing such packet 356.

In some embodiments, based at least in part on this detected change in the SID frame duration (e.g., from SID frame duration 328 to SID frame duration 328′), the frame duration detector component 116 can determine the new SID frame duration 328′ based at least in part on the previous SID frame duration 328 and the difference between when the SID frame packet 356 was expected to be received by the base station 108 and when the SID frame packet 356 actually was received by the base station 108. In other embodiments, the frame duration detector component 116 can determine the new SID frame duration 328′ by triggering (e.g., initiating) and executing (e.g., performing) the SID frame duration detection process that was utilized by the frame duration detector component 116 to learn and determine the previous SID frame duration 328, such as described herein. The slot bypasser controller component 118 can determine an updated defined number of slots for bypassing of periodic uplink grants or an updated defined number of configured grant slots to bypass based at least in part on the determined new SID frame duration 328′. For instance, if the uplink grants are periodic uplink grants, the slot bypass determination component 210 can determine (e.g., calculate) the updated defined number of slots for which periodic uplink grants can be bypassed during a next silent period(s) or next portion(s) of a silent period as a function of the new SID frame duration 328′, the silent period detection threshold value, and the periodic uplink grant period, such as described herein. If, instead, a configured grant is employed, the slot bypass determination component 210 can determine the updated defined number of configured grant slots that can be bypassed during the next silent period(s) or next portion(s) of the silent period as a function of the new SID frame duration 328′, the silent period detection threshold value, and the configured grant periodicity, such as described herein.

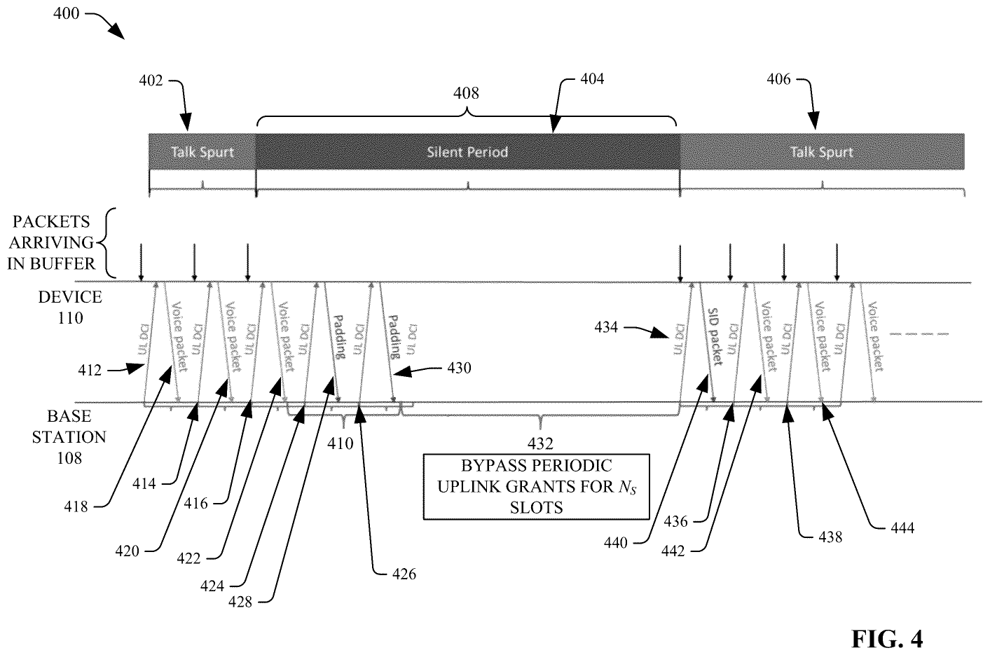

Turning to FIG. 4 (along with FIGS. 1, 2, and 3), FIG. 4 depicts a diagram of a non-limiting example communication session 400, employing periodic uplink grants, where the periodic uplink grants can be controlled and/or bypassed (e.g., during a silent period), in accordance with various aspects and embodiments of the disclosed subject matter. The communication session 400 can involve the device 110 being associated with (e.g., wirelessly communicatively connected to) the base station 108 and utilizing a voice-related service. The communication session 400 can comprise a talk spurt period 402 that can be followed (e.g., immediately followed) by a silent period 404, which can be followed by another talk spurt period 406.

In the example scenario of the communication session 400, the frame duration detector component 116 can determine (e.g., can have previously determined) the SID frame duration 408 (e.g., 320 slots) based at least in part on determining the number of consecutive slots without the base station 108 receiving a voice-related data packet or SID frame packet from the device 110 during a previous silent period (not shown) of the communication session 400, in accordance with the defined communication management criteria and the techniques disclosed herein. In this example scenario, the silent period detection threshold value of the silent period detection threshold 410 can be 80 slots, and the periodic uplink grant period can be 40 slots. Also, in this example scenario, the silent period 404 can span one SID frame duration.

During the talk spurt period 402, the uplink grant scheduler component 212 can periodically communicate respective uplink DCI, such as uplink DCI 412, 414, and 416, comprising respective periodic uplink grants, to the device 110, in accordance with the periodic uplink grant period. The device 110 can be generating voice-related data packets that can be arriving in or inserted into a buffer component (e.g., a MAC buffer) of the device 110. As the device 110 periodically receives the uplink DCI (e.g., 412, 414, and 416) from the base station 108, the device 110 can periodically communicate the voice-related data packets, such as voice-related data packets 418, 420, and 422, in the periodic uplink grant slots to the base station 108. As the device 110 and communication session 400 transitions from the talk spurt period 402 to the silent period 404, the device 110 can still be receiving periodic uplink grants in the received uplink DCI 424 and 426. Since the device 110 does not have any voice-related data to communicate at that time, the device 110 can begin sending padding packets, such as padding packets 428 and 430, in the periodic uplink grant slots of those periodic uplink grants.

The packet identifier component 202 can identify padding packets 428 and 430 as being padding packets based at least in part on the results of analyzing those padding packets 428 and 430. During this time of receiving padding packets 428 and 430, the slot count tracker component 204 can track and increment the number of consecutive slots without the base station 108 receiving a voice-related data packet or SID frame packet from the device 110 during the communication session 400, such as described herein. After padding packet 430 is received by the base station 108, the session state detector component 206 can determine that the communication session 400 has transitioned from the talk spurt period 402 to the silent period 404, based at least in part on determining that the number of consecutive slots without the base station 108 receiving a voice-related data packet or SID frame packet from the device 110 satisfies the silent period detection threshold value (e.g., 80 slots (or 2 periodic uplink grants)), such as described herein.

With the determination that the communication session 400 has transitioned from the talk spurt period 402 to the silent period 404, the uplink communication manager component 114 can determine that periodic uplink grants can be bypassed for a defined number of slots, which can be the remaining portion 432 of the SID frame duration 408, and in this example scenario, the remaining portion of the silent period 404. The slot bypass determination component 210 can determine the number of slots for which periodic uplink grants can be bypassed during the remaining portion 432 of the SID frame duration 408 as a function of the SID frame duration 408 (e.g., 320 slots), the silent period detection threshold value (e.g., 80 slots), and the periodic uplink grant period (e.g., 40 slots). In this example scenario, the slot bypass determination component 210 can determine (e.g., calculate) the defined number of slots (Ns) for which periodic uplink grants can be bypassed as being: N_{S}=320 slots−80 slots−40 slots=200 slots.

The slot bypasser controller component 118, employing the uplink grant scheduler component 212, can control communication of periodic uplink grants to not communicate any periodic uplink grants to the device 110 during or for the defined number of slots (e.g., 200 slots, in this example scenario) during the remaining portion 432 of the SID frame duration 408. As a result of not receiving uplink grants for the defined number of slots during the remaining portion 432 of the SID frame duration 408 (of the silent period 404), the device 110 can bypass communicating, or can otherwise not communicate, data (e.g., padding packets) for the defined number of slots during that remaining portion 432 of the SID frame duration 408 (of the silent period 404).

At or near the end of the SID frame duration 408, the uplink grant scheduler component 212 can communicate uplink DCI, such as uplink DCI 434, 436, and 438, comprising respective periodic uplink grants, to the device 110. Meanwhile, during this time, around the time that the uplink grant scheduler component 212 is communicating the uplink DCI 434, the device 110 can be generating an SID frame packet 440, since the SID frame duration 408 is reaching an end, and the device 110 can insert the SID frame packet 440 in the buffer component to await the periodic uplink grant slot of the periodic uplink grant of the uplink DCI 434. The device 110 can communicate the SID frame packet 440 in the periodic uplink grant slot to the base station 108, in accordance with the periodic uplink grant. The packet identifier component 202 can identify that the SID frame packet 440 is an SID frame packet based at least in part on the results of analyzing the SID frame packet 440. As the device 110 and communication session 400 are transitioning from the silent period 404 to the next talk spurt period 406, the device 110 also can generate voice-related data packets, such as voice-related data packets 442 and 444, and can insert those voice-related data packets into the buffer component. During respective periodic uplink grant slots of the respective periodic uplink grants of the uplink DCI (e.g., 436 and 438), the device 110 can communicate the voice-related data packets (e.g., 442 and 444) to the base station 108. The packet identifier component 202 can identify that the voice-related data packets (e.g., 442 and 444) are voice-related data packets based at least in part on the results of analyzing the voice-related data packets (e.g., 442 and 444). Having received the SID frame packet 440 followed by the voice-related data packet 442 in the next periodic uplink grant slot, the session state detector component 206 can determine that the communication session 400 has transitioned from the silent period 404 to the talk spurt period 406. Accordingly, the slot bypasser controller component 118 can continue to communicate uplink DCI, comprising periodic uplink grants, to the device 110 during the talk spurt period 406, without bypassing periodic uplink grants.

The uplink communication manager component 114 can continue to monitor the communication of data during the communication session 400 to facilitate determining whether the communication session 400 and device 110 transition from one state to another state (e.g., transition from a talk spurt period to a silent period, or vice versa), learning, determining, and/or detecting any change (e.g., modification) to the SID frame duration (if any such change occurs), and/or controlling bypassing periodic uplink grants for the defined number(s) of slots during the silent period(s) (e.g., during a remaining portion of an SID frame duration of the silent period(s)) of the communication session 400, in accordance with the defined communication management criteria.

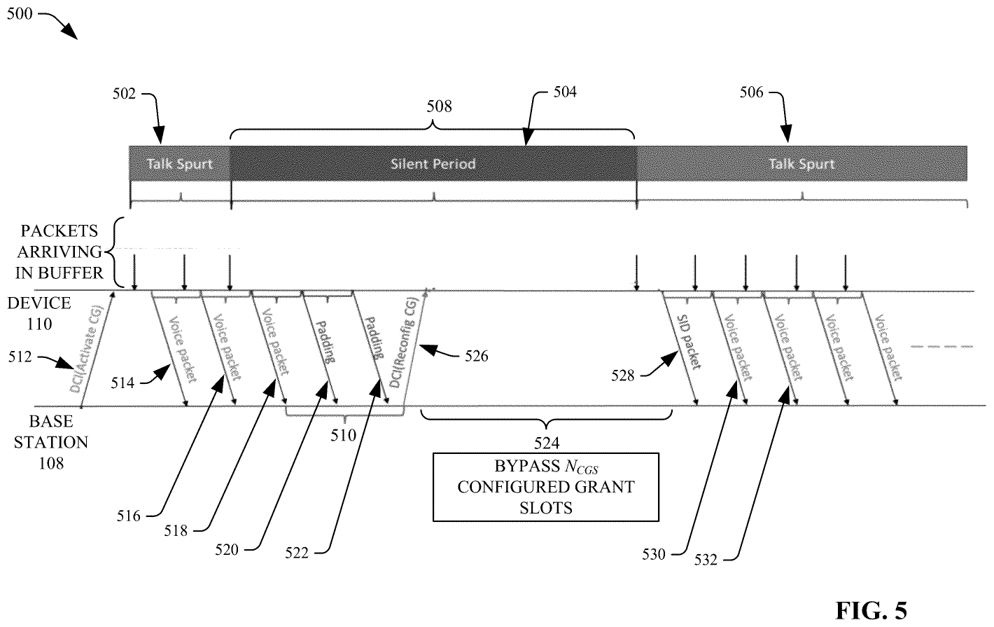

Referring to FIG. 5 (along with FIGS. 1, 2, and 3), FIG. 5 illustrates a diagram of a non-limiting example communication session 500, employing a configured grant, where configured grant slots can be controlled and/or bypassed (e.g., during a silent period), in accordance with various aspects and embodiments of the disclosed subject matter. The communication session 500 can involve the device 110 being associated with (e.g., wirelessly communicatively connected to) the base station 108 and utilizing a voice-related service. The communication session 500 can comprise a talk spurt period 502 that can be followed (e.g., immediately followed) by a silent period 504, which can be followed by another talk spurt period 506.

In the example scenario of the communication session 500, the frame duration detector component 116 can determine (e.g., can have previously determined) the SID frame duration 508 (e.g., 320 slots) based at least in part on determining the number of consecutive slots without the base station 108 receiving a voice-related data packet or SID frame packet from the device 110 during a previous silent period (not shown) of the communication session 500, in accordance with the defined communication management criteria and the techniques disclosed herein. In this example scenario, the silent period detection threshold value of the silent period detection threshold 510 can be 80 slots and the configured grant periodicity can be 40 slots. Also, in this example scenario, the silent period 504 can span one SID frame duration.

In connection with, and prior to, the talk spurt period 502, the uplink grant scheduler component 212 can communicate DCI 512, comprising configured grant information, to the device 110. The device 110 can configure or activate the configured grant, with a configured grant periodicity, and can set up (e.g., establish) the service-related DRB(s) (e.g., VoNR DRB(s)), based at least in part on, and in accordance with, the configured grant information. As part of the communication session 500, the device 110 can be generating voice-related data packets that can be arriving in or inserted into a buffer component of the device 110. The device 110 can periodically communicate the voice-related data packets, such as voice-related data packets 514, 516, and 518, in the configured grant slots to the base station 108, in accordance with the configured grant.

As the device 110 and communication session 500 transitions from the talk spurt period 502 to the silent period 504, the device 110 can still be utilizing configured grant slots, in accordance with the configured grant. Since the device 110 does not have any voice-related data to communicate at that time, the device 110 can begin sending padding packets, such as padding packets 520 and 522, in the configured grant slots.

The packet identifier component 202 can identify padding packets 520 and 522 as being padding packets based at least in part on the results of analyzing those padding packets 520 and 522. During this time of receiving padding packets 520 and 522, the slot count tracker component 204 can track and increment the number of consecutive slots without the base station 108 receiving a voice-related data packet or SID frame packet from the device 110 during the communication session 500, such as described herein. After padding packet 522 is received by the base station 108, the session state detector component 206 can determine that the communication session 500 has transitioned from the talk spurt period 502 to the silent period 504, based at least in part on determining that the number of consecutive slots without the base station 108 receiving a voice-related data packet or SID frame packet from the device 110 satisfies the silent period detection threshold value (e.g., 80 slots (or 2 configured grant slots)), such as described herein.

With the determination that the communication session 500 has transitioned from the talk spurt period 502 to the silent period 504, the uplink communication manager component 114 can determine that a defined number of configured grant slots can be bypassed, which can correspond to the remaining portion 524 of the SID frame duration 508 of the silent period 508 (e.g., in this example scenario, the remaining portion of the silent period 504). The slot bypass determination component 210 can determine the number of configured grant slots that can be bypassed during the remaining portion 524 of the SID frame duration 508 as a function of the SID frame duration 508 (e.g., 320 slots), the silent period detection threshold value (e.g., 80 slots), and the configured grant periodicity (e.g., 40 slots). In this example scenario, the slot bypass determination component 210 can determine (e.g., calculate) the defined number of configured grant slots (N_{CGS}) that can be bypassed as: N_{CGS}=((320 slots−80 slots)/40 slots)−1=5.

The slot bypasser controller component 118, employing the uplink grant scheduler component 212, can control generate DCI 526, comprising configured grant reconfiguration information that can indicate, inform, or instruct that the configured grant is to be reconfigured (e.g., temporarily reconfigured) to bypass the defined number of configured grants slots (e.g., 5 configured grant slots) during the remaining portion 524 of the SID frame duration 508. The base station 108 can communicate the DCI 526 to the device 110. The device 110, employing the slot bypasser component 120, can reconfigure the configured grant to bypass the defined number of configured grant slots during the remaining portion 526 of SID frame duration 508 of the silent period 504. As a result of such bypassing, the device 110 desirably can bypass communicating, or can otherwise not communicate, data (e.g., padding packets) for the defined number of configured grant slots.

At or near the end of the SID frame duration 508, the device 110 can be generating an SID frame packet 528, since the SID frame duration 508 is reaching an end, and the device 110 can insert the SID frame packet 528 in the buffer component to await the next configured grant slot, in accordance with the configured grant (e.g., the original configured grant received with the DCI 512). The device 110 can communicate the SID frame packet 528 in the configured grant slot to the base station 108, in accordance with the configured grant. The packet identifier component 202 can identify that the SID frame packet 528 is an SID frame packet based at least in part on the results of analyzing the SID frame packet 528. As the device 110 and communication session 500 are transitioning from the silent period 504 to the next talk spurt period 506, the device 110 also can generate voice-related data packets, such as voice-related data packets 530 and 532, and can insert those voice-related data packets into the buffer component. During respective configured grant slots of the configured grant, the device 110 can communicate the voice-related data packets (e.g., 530 and 532) to the base station 108. The packet identifier component 202 can identify that the voice-related data packets (e.g., 530 and 532) are voice-related data packets based at least in part on the results of analyzing the voice-related data packets (e.g., 530 and 532). Having received the SID frame packet 528 in a configured grant slot at the end of the SID frame duration 508 followed by the voice-related data packet 530 in the next configured grant slot, the session state detector component 206 can determine that the communication session 500 has transitioned from the silent period 504 to the talk spurt period 506. Accordingly, the slot bypasser controller component 118 can determine that there is to be no bypassing of configured grant slots during the talk spurt period 506, and the device 110 can continue to communicate voice-related data packets (e.g., 532) in configured grant slots to the base station 108, in accordance with the configured grant.

The uplink communication manager component 114 can continue to monitor the communication of data during the communication session 500 to facilitate determining whether the communication session 500 and device 110 transition from one state to another state (e.g., transition from a talk spurt period to a silent period, or vice versa), learning, determining, and/or detecting any change (e.g., modification) to the SID frame duration (if any such change occurs), and/or controlling bypassing of configured grant slots (e.g., the defined number(s) of configured grant slots) during the silent period(s) (e.g., during a remaining portion of an SID frame duration of the silent period(s)) of the communication session 500, in accordance with the defined communication management criteria.

With further regard to FIGS. 1 and 2, in accordance with various embodiments, the uplink communication manager component 114 can comprise or be associated with an artificial intelligence (AI) component 214 that can employ AI, machine learning, and/or other AI-type techniques and algorithms to determine or predict an SID frame duration for a communication session, determine or predict whether an SID frame duration has changed during a communication session, determine or predict a session state of a communication session, determine or predict whether a silent period detector threshold is satisfied, determine or predict a length a silent period detector threshold should be for a communication session, determine or predict a number of slots for which periodic uplink grants can be bypassed for a communication session, determine or predict a number of configured grant slots that can be bypassed for a communication session, and/or perform other desired functions or operations. In some embodiments, the AI component 214 can comprise, generate, and/or train machine learning models 216 that can be trained to determine or predict an SID frame duration for a communication session, determine or predict whether an SID frame duration has changed during a communication session, determine or predict a session state of a communication session, determine or predict whether a silent period detector threshold is satisfied, determine or predict a length a silent period detector threshold should be for a communication session, determine or predict a number of slots for which periodic uplink grants can be bypassed for a communication session, determine or predict a number of configured grant slots that can be bypassed for a communication session, and/or perform other desired functions or operations.

For instance, the AI component 214 can employ a trainer component 218 that can train (or refine or update training of) a (trained) machine learning model 216 to learn to determine or predict an SID frame duration for a communication session, determine or predict whether an SID frame duration has changed during a communication session, determine or predict a session state of a communication session, determine or predict whether a silent period detector threshold is satisfied, determine or predict a length a silent period detector threshold should be for a communication session, determine or predict a number of slots for which periodic uplink grants can be bypassed for a communication session, determine or predict a number of configured grant slots that can be bypassed for a communication session, and/or perform other desired functions or operations, based at least in part on application of training data and/or feedback information (e.g., via a feedback component 220) relating to previous communication sessions associated with the device (e.g., 110) or other devices (e.g., 112), a current communication session associated with the device (e.g., 110), SID frame durations, silent period detector thresholds, periodic uplink grant bypassing, and/or configured grant slot bypassing, to the (trained) machine learning model 216. Such training of the trained machine learning model 216 can enable the trained machine learning model 216 to learn to identify respective (e.g., different types of) data patterns in data (e.g., information relating to devices, codecs, services, network components, communication sessions, SID frame durations, silent period detector thresholds, periodic uplink grant bypassing, and/or configured grant slot bypassing, and/or the other desired information) being analyzed by the trained machine learning model 216 and distinguish between data patterns in the data (if any) that can indicate, for example, desirable (e.g., suitable, wanted, enhanced, or optimal) determinations or predictions of an SID frame duration for a communication session, determinations or predictions of whether an SID frame duration has changed during a communication session, determinations or predictions of a session state of a communication session, determinations or predictions of whether a silent period detector threshold is satisfied, determinations or predictions of a length a silent period detector threshold should be for a communication session, determinations or predictions of a number of slots for which periodic uplink grants can be bypassed for a communication session, and/or determinations or predictions of a number of configured grant slots that can be bypassed for a communication session.

In certain embodiments, the trained machine learning model 216 can perform a machine learning-based analysis on information relating to devices, codecs, services, network components, communication sessions, SID frame durations, silent period detector thresholds, periodic uplink grant bypassing, and/or configured grant slot bypassing, and/or the other desired information. Based at least in part on the results of the machine learning-based analysis on such information, the trained machine learning model 216 can determine, predict, or infer an SID frame duration for a communication session, determine, predict, or infer whether an SID frame duration has changed during a communication session, determine, predict, or infer a session state of a communication session, determine, predict, or infer whether a silent period detector threshold is satisfied, determine, predict, or infer a length a silent period detector threshold should be for a communication session, determine, predict, or infer a number of slots for which periodic uplink grants can be bypassed for a communication session, determine, predict, or infer a number of configured grant slots that can be bypassed for a communication session, and/or perform other desired functions or operations. For example, based at least in part on the machine learning-based analysis results, the trained machine learning model 216 can determine whether there are one or more data patterns in the data that can indicate what an SID frame duration for a new communication session associated with a device can or will be, or can indicate a change in an SID frame duration during a communication session. In some embodiments, the trained machine learning model 216 can determine a probability (e.g., probability value) that an SID frame duration for a new communication session associated with a device can be a particular duration. The uplink communication manager component 114, AI component 214, or the trained machine learning model 216 can determine an SID frame duration to utilize for a new communication session associated with a device based at least in part on the probability and a defined threshold probability (e.g., a defined threshold probability value) relating to SID frame duration, and/or based at least in part on whether there are one or more data patterns in the data that can indicate an SID frame duration that can be utilized for a new communication session associated with a device.

For instance, the uplink communication manager component 114, AI component 214, or the trained machine learning model 216 can compare the probability to the defined threshold probability to determine whether the probability satisfies (e.g., meets or exceeds; is at or greater than) the defined threshold probability. If, based at least in part on the results of such comparison, the uplink communication manager component 114, AI component 214, or the trained machine learning model 216 determines that the probability does not satisfy (e.g., is less than) the defined threshold probability, the uplink communication manager component 114, AI component 214, or the trained machine learning model 216 can determine that the SID frame duration is not to be utilized, a different SID frame duration is to be utilized, or an SID frame duration is to be determined (e.g., using the SID frame duration detection process), for the new communication session associated with the device. If, instead, based at least in part on the comparison results, the uplink communication manager component 114, AI component 214, or the trained machine learning model 216 determines that the probability does satisfy the defined threshold probability, the uplink communication manager component 114, AI component 214, or the trained machine learning model 216 can determine that the SID frame duration can be utilized for the new communication session associated with the device.

With further regard to the AI component 214, the AI component 214 can perform an AI and/or machine learning-based analysis on data, such as information relating to communication networks, RANs, cells, resources, devices, codecs, network components, periodic uplink grants, configured grants, DCI, communication sessions, PDU session data, SID frames, SID frame durations, silent period detector thresholds, periodic uplink grant bypassing, configured grant slot bypassing, training data, feedback information, files, services, applications, messages, notifications, alarms, alerts, preferences (e.g., user or client preferences), hash values, metadata, parameters, traffic flows, policies, defined uplink communication management criteria, algorithms (e.g., enhanced uplink communication management algorithms, enhanced uplink grant scheduling algorithm(s), and/or other algorithm), protocols, tools, and/or other information, such as more fully described herein. In connection with or as part of such an AI or machine learning-based analysis, the AI component 214 can employ, build (e.g., construct or create), and/or import, AI and/or machine learning techniques and algorithms, AI and/or machine learning models 216 (e.g., trained models), neural networks (e.g., trained neural networks), Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about an SID frame duration for a communication session, determining or learning about a change in an SID frame duration during a communication session, determining or learning about a session state or a change of session state of a communication session, determining or learning about whether a silent period detector threshold of a communication session is satisfied, determining or learning a desirable length of a silent period detector threshold for a communication session, determining or learning a desirable number of slots for which periodic uplink grants can be bypassed for a communication session, determining or learning a desirable number of configured grant slots that can be bypassed for a communication session, and/or perform other desired functions or operations and/or automating one or more functions or features of the disclosed subject matter, as more fully described herein.

Based at least in part on the results of the analysis, the AI component 214 can determine, train, and generate one or more models 216 (e.g., machine learning model or other model), such as described herein, wherein the models can model or be representative of respective features and/or respective historical performance of the communication network, RAN, cells, devices, services, communication sessions, and/or other functions, features, or operations, such as described herein. The AI component 214 can update (e.g., modify, adjust, refine, or change), and further train and enhance, the model 216 as additional data (e.g., information relating to further operation of the communication network, cells, devices, services, and/or communication sessions; output results output from the machine learning model (which can be at least some of the feedback information); the feedback information; and/or other information) is received and analyzed by the AI component 214 or model 216. In some embodiments, as part of the data analysis, and the determining and training of the models 216, the AI component 214 can employ (and/or train) Markov chains, a neural network(s), or other AI-based or machine learning-based modeling, techniques, functions, or algorithms.

The AI component 214 can employ various AI-based or machine learning-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 214 can examine the entirety or a subset of the data (e.g., the training data, the feedback information, other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f (z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

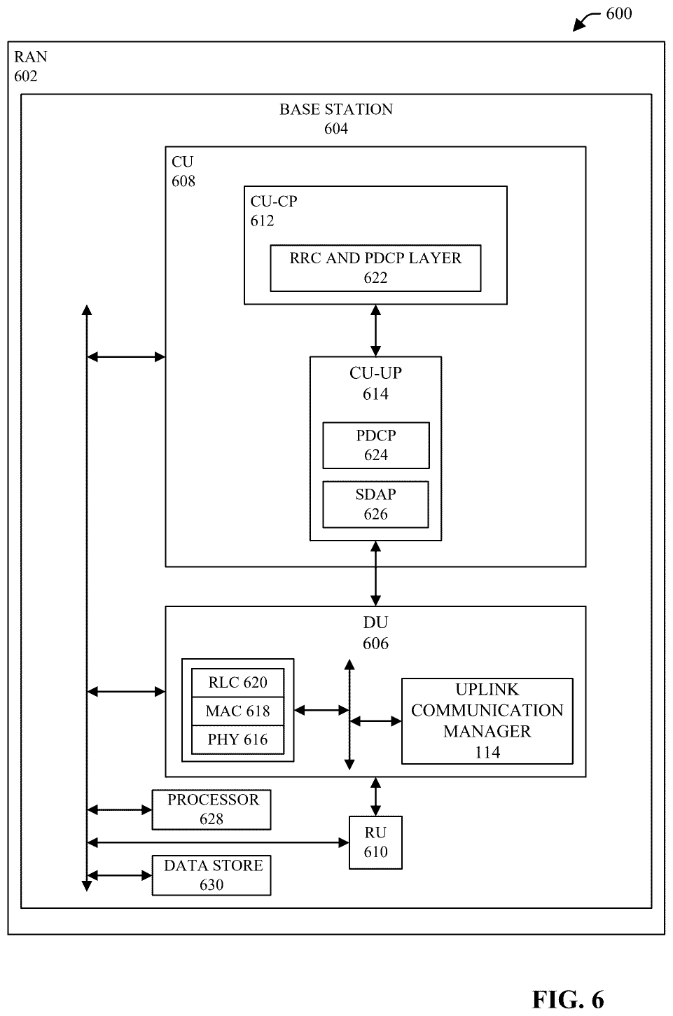

Turning to FIG. 6 (along with FIGS. 1 and 2), FIG. 6 illustrates a block diagram of non-limiting example system 600 that can comprise the RAN 602, which can comprise the uplink communication manager component 114 (e.g., in or associated with a base station 604 of the RAN 602) that can desirably (e.g., automatically, dynamically, suitably, reliably, efficiently, enhancedly, and/or optimally) learn and determine (e.g., adaptively and/or continuously learn and determine) an SID frame duration of communication of SID frames by a device during a communication session of the device, control bypassing of certain uplink grant slots during a silent period(s) of the communication session (e.g., based at least in part on the SID frame duration), and mitigate wastage of uplink air interface resources and/or other resources of the device or the communication network 102, in accordance with various aspects and embodiments of the disclosed subject matter. In some embodiments, the system 600 can be part of the system 100 depicted in FIG. 1.

In some embodiments, the RAN 602 can be an open-RAN (O-RAN) that can be part of an O-RAN architecture and environment (e.g., the communication network 102 can employ an O-RAN architecture and environment). In certain embodiments, the RAN 602 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 602 may not be an O-RAN, C-RAN, or vRAN.

In accordance with various embodiments, the RAN 602 can comprise the base station 604 (e.g., a gNB or NR-NB) that can comprise a DU 606 (e.g., a gNB or other NR-NB DU), a central unit (CU) 608, and a radio unit (RU) 610 (e.g., a gNB or other NR-NB RU). The CU 608 can comprise a CU-control plane (CP) 612 (e.g., a gNB or other NR-NB CU-CP node) and a CU-user plane (UP) 614 (e.g., a gNB or other NR-NB CU-UP node). The DU 606 can comprise or be associated with the uplink communication manager component 114. In certain embodiments, the RAN 602 and/or the base station 604 can comprise multiple DUs, multiple CU-CPs, multiple CU-UPs, and/or multiple RUs.

The DU 606 can be a logical node that can host or handle baseband (e.g., physical layer (PHY) 616) and layer 2 (L2) (e.g., a MAC layer 618 and a radio link control (RLC) layer 620) functionality associated with the base station 604. The CU-CP 612 (also referred to as a CU-CP node) can be a logical node that can host or handle layer 3 (L3) (e.g., a radio resource control (RRC) and packet data convergence protocol (PDCP) layer 622) control plane functionality associated with the base station 604. The CU-UP 614 (also referred to as a CU-UP node) can be a logical node that can host or handle data traffic between the core network 104 (e.g., 5G core network) and the DU (e.g., 606) to which the CU-UP 614 is connected. In some embodiments, the CU-UP 614 can comprise a PDCP component (PDCP) 624 that can perform PDCP functions, and a service data adaptation protocol (SDAP) component (SDAP) 626 that can perform SDAP functions. The RU 610 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 602 and other devices (e.g., devices 110 and/or 112) or components (e.g., components or functions of the core network 104 or communication network 102). In accordance with various embodiments, the DU 606 can comprise the uplink communication manager component 114 that can desirably detect or determine when a device (e.g., device 110), utilizing a service (e.g., voice-related service), is in a silent period of a communication session associated with the device, learn and determine (e.g., adaptively and/or continuously learn and determine) an SID frame duration of communication of SID frames by the device during the silent period of the communication session, determine slots (e.g., periodic uplink grant slots or configured grant slots) that can be bypassed during the silent period based at least in part on the SID frame duration, bypass or facilitate bypassing periodic uplink grants for the periodic uplink grant slots or bypassing configured grant slots for the configured grant, and mitigate wastage of uplink air interface resources and/or other resources of the communication network 102 and/or the device, in accordance with the defined communication management criteria, such as described herein.

In certain embodiments, as disclosed, the system 600 can comprise an O-RAN architecture and environment, and the RAN 602 can be an O-RAN. In some embodiments, in the O-RAN architecture and environment, the system 600 also can comprise a service management and orchestration (SMO) component and a RIC (not shown in FIG. 6), wherein the SMO component can be associated with (e.g., communicatively connected to) the RIC and/or the RAN 602 (and/or one or more other RANs) via an interface(s) (e.g., an O1 interface, an AI interface, or another interface), to facilitate communication of information between the SMO component and the RIC and/or the RAN 602 (and/or one or more other RANs), and the RIC can be associated with the RAN 602 (and/or one or more other RANs) via an interface(s) (e.g., an E2 interface or another interface), to facilitate communication of information between the RIC and the RAN 602 (and/or one or more other RANs).

The SMO component can act and operate as a management and orchestration layer that can control configuration and automation aspects of the RIC and RAN elements of the RAN(s). The SMO component can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time. The RIC can operate to control (e.g., manage) and enhance (e.g., improve or optimize) RAN functions and services of the RAN(s). At least some of the various network functions and components of the RIC can operate in real time or near real time, and some network functions and components of the RIC may operate in non-real time.

In accordance with various embodiments, the RAN 602 can comprise a processor component 628 that can be associated with (e.g., communicatively connected to) and can work in conjunction with other components of the RAN 602, including the base station 604, the DU 606, the CU 608, the RU 610, the uplink communication manager component 114, a data store 630, and/or other components of the RAN 602, to facilitate performing the various functions and operations of the RAN 602. The processor component 628 can employ one or more processors (e.g., one or more central processing units (CPUs)), microprocessors, or controllers that can process information relating to data, files, services, applications, communication networks, RANs, cells, devices, resources, periodic uplink grants, configured grants, DCI, communication sessions, PDU session data, SID frames, SID frame duration, threshold values or levels (e.g., the silent period detection threshold value), data processing operations, messages, notifications, alarms, alerts, preferences (e.g., user or client preferences), hash values, metadata, parameters, traffic flows, policies, the defined uplink communication management criteria, algorithms (e.g., enhanced uplink communication management algorithms, enhanced uplink grant scheduling algorithm(s), downlink scheduling algorithm(s), hash algorithms, data compression algorithms, data decompression algorithms, and/or other algorithm), interfaces, protocols, tools, and/or other information, to facilitate operation of the RAN 602, and control data flow between the RAN 602 and/or other components (e.g., network components, another RAN, the communication network 102, a device (e.g., 110 or 112), a node, a service, a user, or other entity) associated with the RAN 602.

The data store 630 can store data structures (e.g., user data, metadata), code structure(s) (e.g., modules, objects, hashes, classes, procedures) or instructions, information relating to data, files, services, applications, communication networks, RANs, cells, devices, resources, periodic uplink grants, configured grants, DCI, communication sessions, PDU session data, SID frames, SID frame duration, threshold values or levels (e.g., the silent period detection threshold value), data processing operations, messages, notifications, alarms, alerts, preferences (e.g., user or client preferences), hash values, metadata, parameters, traffic flows, policies, the defined uplink communication management criteria, algorithms (e.g., enhanced uplink communication management algorithms, enhanced uplink grant scheduling algorithm(s), downlink scheduling algorithm(s), hash algorithms, data compression algorithms, data decompression algorithms, and/or other algorithm), interfaces, protocols, tools, and/or other information, to facilitate controlling or performing operations associated with the RAN 602. The data store 630 can comprise volatile and/or non-volatile memory, such as described herein. In an aspect, the processor component 628 can be functionally coupled (e.g., through a memory bus) to the data store 630 in order to store and retrieve information desired to operate and/or confer functionality, at least in part, to the base station 604, DU 606, CU 608, RU 610, uplink communication manager component 114, processor component 628, data store 630, and/or other component of the RAN 602, and/or substantially any other operational aspects of RAN 602.

As disclosed, the data store 630 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

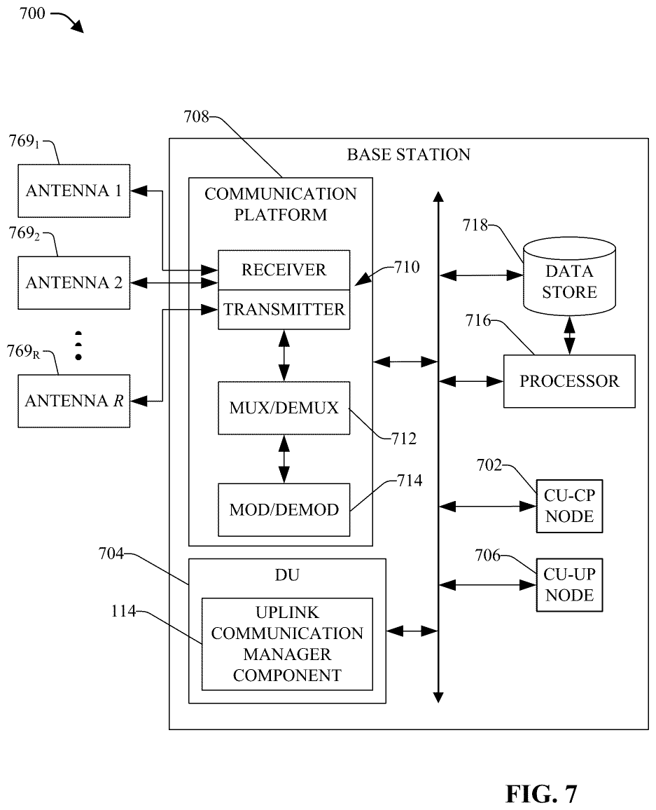

Turning to FIG. 7, FIG. 7 depicts a diagram of a non-limiting example base station 700 that can desirably facilitate (e.g., enable) connections (e.g., wireless connections) and communication of information associated with devices, in accordance with various aspects and embodiments of the disclosed subject matter. In some embodiments, the base station 700 can be a 5G or other NR base station (e.g., gNB or other NR-type or xG base station, wherein x can be a number greater than 5). In other embodiments, the base station 700 can be a 4G or LTE base station, or some other type of base station (e.g., other type of access point).

With regard to a 5G or other NR base station, the base station 700 can comprise a CU-CP node 702 (e.g., a gNB or other NR-NB CU-CP node), one or more DUs (e.g., a gNB or other NR-NB DUs), including DU 704, a desired number of CU-UP nodes (e.g., a gNB or other NR-NB CU-UP nodes), including CU-UP node 706, and/or other network equipment. The CU-CP node 702 can be associated or interfaced with the DUs (e.g., DU 704) via an interface (e.g., F1-C interface) or connection. The CU-CP node 702 can be associated or interfaced with the CU-UP node(s) (e.g., CU-UP node 706) via an interface (e.g., E1 interface) or connection. The CU-UP node(s) (e.g., CU-UP node 706) can be associated or interfaced with the one or more DUs (e.g., DU 704) via an interface (e.g., F1-U interface) or connection.

A DU (e.g., DU 704) can provide support for lower layers of a protocol stack. For instance, a DU (e.g., DU 704) can be a logical node that can host or handle baseband (e.g., PHY) and L2 (e.g., MAC and RLC layer) functionality associated with the base station 700. A CU-UP node (e.g., CU-UP node 706) can be a logical node that can host or handle data traffic between the core network 104 (e.g., 5G or other NR or xG core network) and the DU(s) (e.g., DU 704) to which the particular CU-UP is connected. The CU-CP node 702 can be a logical node that can host or handle L3 (e.g., RRC and PDCP layer) control plane functionality associated with the base station 700.

In some embodiments, a device(s) (e.g., device(s) 111 and/or 112) can be connected to the base station 700, via the DU 704, wherein one or more CU-UP nodes (e.g., CU-UP node 706) and the DU 704 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the service or other device) via the base station 700.

The base station 700 can receive and transmit signal(s) from and to wireless devices like access points (e.g., base stations, femtocells, picocells, or other type of access point), access terminals (e.g., UEs), wireless ports and routers, and the like, through a set of antennas 7691-769R. In an aspect, the antennas 7691-769R can be a part of a communication platform 708, which can comprise electronic components and associated circuitry that can provide for processing and manipulation of received signal(s) and signal(s) to be transmitted. In an aspect, the communication platform 708 can include a receiver/transmitter 710 that can convert signal from analog to digital upon reception, and from digital to analog upon transmission. In addition, receiver/transmitter 710 can divide a single data stream into multiple, parallel data streams, or perform the reciprocal operation. In accordance with various embodiments, the communication platform 708 can be, can comprise, or can be associated with an RU(s) (e.g., a gNB or other NR-NB RU node(s)).

In an aspect, coupled to receiver/transmitter 710 can be a multiplexer/demultiplexer (mux/demux) 712 that can facilitate manipulation of signal in time and frequency space. The mux/demux 712 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 712 can scramble and spread information (e.g., codes) according to substantially any code known in the art, e.g., Hadamard-Walsh codes, Baker codes, Kasami codes, polyphase codes, and so on. A modulator/demodulator (mod/demod) 714 also can be part of the communication platform 708, and can modulate information according to multiple modulation techniques, such as frequency modulation, amplitude modulation (e.g., M-ary quadrature amplitude modulation (QAM), with M a positive integer), phase-shift keying (PSK), and the like.

The base station 700 also can comprise a processor(s) 716 that can be configured to confer and/or facilitate providing functionality, at least partially, to substantially any electronic component in or associated with the base station 700. For instance, the processor(s) 716 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data, such as described herein.

In another aspect, the base station 700 can include a data store 718 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with data, files, services, applications, communication networks, RANs, cells, devices, resources, periodic uplink grants, configured grants, DCI, communication sessions, PDU session data, SID frames, SID frame duration, threshold values or levels (e.g., the silent period detection threshold value), data processing operations, messages, notifications, alarms, alerts, preferences (e.g., user or client preferences), hash values, metadata, parameters, traffic flows, policies, the defined uplink communication management criteria, algorithms (e.g., enhanced uplink communication management algorithms, enhanced uplink grant scheduling algorithm(s), downlink scheduling algorithm(s), hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on. The processor(s) 716 can employ one or more processors (e.g., one or more CPUs), microprocessors, or controllers) that can process information, and can be coupled to the data store 718 in order to store and retrieve at least some of the information (e.g., information, such as algorithms, relating to multiplexing/demultiplexing or modulation/demodulation; information relating to radio link levels; information relating to data, files, services, applications, communication networks, RANs, cells, devices, resources, periodic uplink grants, configured grants, DCI, communication sessions, PDU session data, SID frames, SID frame duration, threshold values or levels (e.g., the silent period detection threshold value), data processing operations, messages, notifications, alarms, alerts, preferences (e.g., user or client preferences), hash values, metadata, parameters, traffic flows, policies, the defined uplink communication management criteria, algorithms (e.g., enhanced uplink communication management algorithms, enhanced uplink grant scheduling algorithm(s), downlink scheduling algorithm(s), hash algorithms, data compression algorithms, data decompression algorithms, and/or other algorithm), interfaces, protocols, tools, and/or other information) desired to operate and/or confer functionality to the communication platform 708 and/or other operational components of the base station 700. The data store 718 can comprise volatile memory and/or nonvolatile memory, such as described herein.

In accordance with various embodiments, the base station 700 (e.g., the DU 704 of the base station 700) can comprise or be associated with the uplink communication manager component 114 that can that can desirably (e.g., automatically, dynamically, suitably, reliably, efficiently, enhancedly, and/or optimally) detect or determine when a device (e.g., device 110), utilizing a service (e.g., voice-related service), is in a silent period of a communication session, learn and determine (e.g., adaptively and/or continuously learn and determine) an SID frame duration of communication of SID frames by the device during the communication session, determine slots (e.g., periodic uplink grant slots or configured grant slots) that can be bypassed during the silent period based at least in part on the SID frame duration, bypass or facilitate bypassing periodic uplink grants for such periodic uplink grant slots or bypassing configured grant slots, and mitigate wastage of uplink air interface resources and/or other resources of the device or the communication network 102, in accordance with the defined communication management criteria, such as described herein.

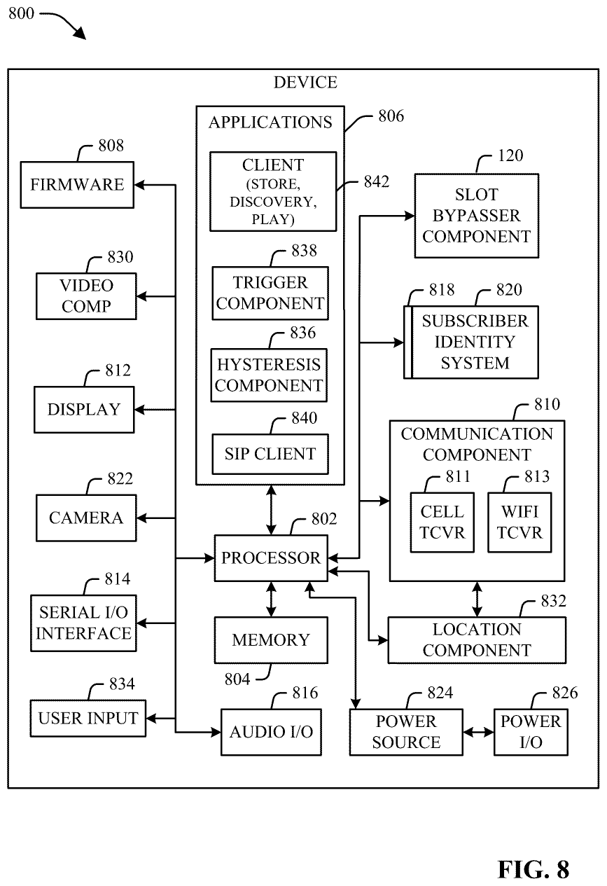

Referring to FIG. 8, FIG. 8 illustrates a diagram of a non-limiting example device 800 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 800 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 800, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 800 can include a processor(s) 802 for controlling and processing all onboard operations and functions. The processor(s) 802 can comprise one or more processors (e.g., one or more central processing units (CPUs)), microprocessors, or controllers) that can process information associated with the device 800. A memory 804 can interface to the processor(s) 802 for storage of data and one or more applications 806 (e.g., a video player software, user feedback component software, etc.). Other applications can include voice recognition of predetermined voice commands that facilitate initiation of the user feedback signals. The applications 806 can be stored in the memory 804 and/or in a firmware 808, and executed by the processor(s) 802 from either or both the memory 804 or/and the firmware 808. The firmware 808 can also store startup code for execution in initializing the device 800. A communication component 810 interfaces to the processor(s) 802 to facilitate wired/wireless communication with external systems, e.g., cellular networks, VoIP networks, and so on. Here, the communication component 810 can also include a suitable cellular transceiver 811 (e.g., a global system for mobile communication (GSM), orthogonal frequency division multiple access (OFDMA), 4G, LTE, 5G, other NR, or other type of transceiver) and/or an unlicensed transceiver 813 (e.g., Wi-Fi, WiMax) for corresponding signal communications. The device 800 can be a device such as a cellular telephone, a PDA with mobile communications capabilities, and messaging-centric devices. The communication component 810 also facilitates communications reception from terrestrial radio networks (e.g., broadcast), digital satellite radio networks, and Internet-based radio services networks.

The device 800 includes a display 812 for displaying text, images, video, telephony functions (e.g., a Caller ID function), setup functions, and for user input. For example, the display 812 can also be referred to as a “screen” that can accommodate the presentation of multimedia content (e.g., music metadata, messages, wallpaper, graphics, etc.). The display 812 can also display videos and can facilitate the generation, editing and sharing of video quotes. A serial I/O interface 814 is provided in communication with the processor(s) 802 to facilitate wired and/or wireless serial communications (e.g., USB, and/or IEEE 1394) through a hardwire connection, and other serial input devices (e.g., a keyboard, keypad, and mouse). This supports updating and troubleshooting the device 800, for example. Audio capabilities are provided with an audio I/O component 816, which can include a speaker for the output of audio signals related to, for example, indication that the user pressed the proper key or key combination to initiate the user feedback signal. The audio I/O component 816 also facilitates the input of audio signals through a microphone to record data and/or telephony voice data, and for inputting voice signals for telephone conversations.

The device 800 can include a slot interface 818 for accommodating a SIC (Subscriber Identity Component) in the form factor of a card Subscriber Identity Module (SIM) or universal SIM 820, and interfacing the SIM card 820 with the processor(s) 802. However, it is to be appreciated that the SIM card 820 can be manufactured into the device 800, and updated by downloading data and software.

The device 800 can process IP data traffic through the communication component 810 to accommodate IP traffic from an IP network such as, for example, the Internet, a corporate intranet, a home network, a person area network, etc., through an ISP or broadband cable provider. Thus, VoIP traffic can be utilized by the device 800 and IP-based multimedia content can be received in either an encoded or a decoded format.

A video processing component 822 (e.g., a camera) can be provided for decoding encoded multimedia content. The video processing component 822 can aid in facilitating the generation, editing, and sharing of video quotes. The device 800 also includes a power source 824 in the form of batteries and/or an AC power subsystem, which power source 824 can interface to an external power system or charging equipment (not shown) by a power I/O component 826.

The device 800 can also include a video component 830 for processing video content received and for recording and transmitting video content. For example, the video component 830 can facilitate the generation, editing and sharing of video quotes. A location tracking component 832 facilitates geographically locating the device 800. As described hereinabove, this can occur when the user initiates the feedback signal automatically or manually. A user input component 834 facilitates the user initiating the quality feedback signal. The user input component 834 can also facilitate the generation, editing and sharing of video quotes. The user input component 834 can include such conventional input device technologies such as a keypad, keyboard, mouse, stylus pen, and/or touch screen, for example.

Referring again to the applications 806, a hysteresis component 836 facilitates the analysis and processing of hysteresis data, which is utilized to determine when to associate with the access point. A software trigger component 838 can be provided that facilitates triggering of the hysteresis component 836 when the Wi-Fi transceiver 813 detects the beacon of the access point. A SIP client 840 enables the device 800 to support SIP protocols and register the subscriber with the SIP registrar server. The applications 806 can also include a client 842 that provides at least the capability of discovery, play and store of multimedia content, for example, music.

The device 800, as indicated above related to the communication component 810, includes an indoor network radio transceiver 813 (e.g., Wi-Fi transceiver). This function supports the indoor radio link, such as IEEE 802.11, for the dual-mode GSM device (e.g., device 800). The device 800 can accommodate at least satellite radio services through a device (e.g., handset device) that can combine wireless voice and digital radio chipsets into a single device (e.g., single handheld device).

In some embodiments, the device 800 can comprise the slot bypasser component 120 that can reconfigure a configured grant to bypass a defined number of configured grant slots during a silent period (e.g., the portion of the silent period between the communication of SID frames by the device 800) of a communication session, such as described herein.

It is to be appreciated and understood that one or more components (e.g., the devices, uplink communication manager component, base station, core network, or other component) of the systems (e.g., system 100, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

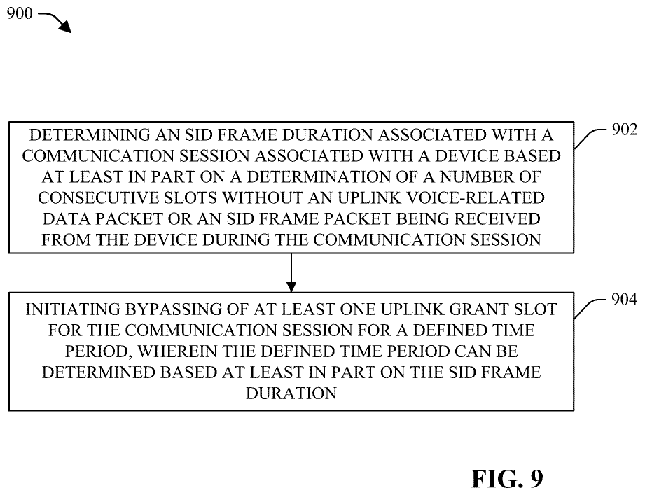

In view of the example systems and/or devices described herein, example methods that can be implemented in accordance with the disclosed subject matter can be further appreciated with reference to flowcharts in FIGS. 9-13. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 9 illustrates a flow chart of an example method 900 that can desirably (e.g., automatically, dynamically, suitably, reliably, efficiently, enhancedly, and/or optimally) learn and determine (e.g., adaptively and/or continuously learn and determine) an SID frame duration of communication of SID frames by a device during a communication session of the device, and bypass certain uplink grant slots during a silent period of the communication session (e.g., based at least in part on the SID frame duration), to facilitate mitigating wastage of uplink air interface resources and/or other resources of the device or the communication network, in accordance with various aspects and embodiments of the disclosed subject matter. The method 900 can be employed by, for example, a system comprising the uplink communication manager component, which can comprise or be associated with the processor component, the data store, and/or other components.

At 902, an SID frame duration associated with a communication session associated with a device can be determined based at least in part on a determination of a number of consecutive slots without an uplink voice-related data packet or an SID frame packet being received from the device during the communication session. The uplink communication manager component, employing the frame duration detector component, can monitor the data packets being communicated by the device to the base station, and, based at least in part on the monitoring, can detect when the communication session transitions from the talk spurt state to the silent period based at least in part on detecting that the device has gone from communicating voice-related data packets to communicating padding (e.g., padding packets) such that the number of slots without a voice-related data packet or an SID frame (e.g., SID frame packet) being received from the device is determined to satisfy the defined threshold consecutive number of slots relating to (e.g., indicative of) the silent period. The frame duration detector component can continue to monitor the data packets being received from the device during respective slots (e.g., uplink time slots) during the silent period, and, based at least in part on the monitoring, can detect when an SID frame (or a voice-related data packet) is received from the device. The frame duration detector component can determine the number of consecutive slots without the uplink voice-related data packet or the SID frame being received from the device during the silent period of the communication session. Based at least in part on the determination of the number of consecutive slots without the uplink voice-related data packet or the SID frame being received from the device during the silent period of the communication session, the frame duration detector component can determine the SID frame duration associated with the communication session associated with the device, such as described herein.

At 904, bypassing of at least one uplink grant slot for the communication session for a defined time period can be initiated, wherein the defined time period can be determined based at least in part on the SID frame duration. The uplink communication manager component, employing the slot bypasser controller component, can initiate bypassing of at least the one uplink grant slot during the silent period of the communication session for the defined time period (e.g., a defined number of slots, for periodic uplink grants; or a defined number of configured grant slots, for a configured grant) that can be determined (e.g., by the uplink communication manager component) based at least in part on the SID frame duration. For instance, if the uplink grants are periodic uplink grants, the uplink communication manager component can determine (e.g., calculate) a defined number of slots for which at least the one periodic uplink grant slot is to be bypassed as a function of the SID frame duration, the threshold number of consecutive slots relating to the silent period, and a periodic uplink grant period of the periodic uplink grants associated with the communication session, such as described herein. The slot bypasser controller component can control communication of periodic uplink grants to not communicate any periodic uplink grants to the device during the defined number of slots during the silent period (e.g., during a portion of the silent period between the communicating of SID frames by the device). As a result of not receiving uplink grants for the defined number of slots, the device can bypass communicating, or can otherwise not communicate, data (e.g., padding) for the defined number of slots. Given the determined SID frame duration, after the defined number of slots, the base station can expect a next SID frame, if the silent period is to continue, or a next voice-related data packet, if the communication session is transitioning from the silent period to the next talk spurt state.

With regard to when a configured grant is employed for the communication session, the uplink communication manager component can determine (e.g., calculate) a defined number of configured grant slots (where the at least one uplink grant slot can be one or more configured grants slots) that is to be bypassed during the communication session (e.g., during a portion of the silent period of the communication session) as a function of the SID frame duration, the threshold number of consecutive slots relating to the silent period, and a configured grant periodicity of the configured grant, such as described herein. The slot bypasser controller component can initiate and control bypassing of the defined number of configured grant slots by communicating DCI to the device, wherein the DCI can instruct or inform the device to bypass the defined number of configured grant slots during the silent period (e.g., during a portion of the silent period between the communicating of SID frames by the device). Based at least in part on the DCI, the device can reconfigure the configured grant to bypass the defined number of configured grant slots during the silent period. As a result of such bypassing, the device can bypass communicating, or can otherwise not communicate, data (e.g., padding) for the defined number of configured grant slots during the silent period (e.g., during the portion of the silent period between the communicating of SID frames by the device). Given the determined SID frame duration, after the defined number of configured grant slots, the base station can expect a next SID frame, if the silent period is to continue, or a next voice-related data packet, if the communication session is transitioning from the silent period to the next talk spurt state.

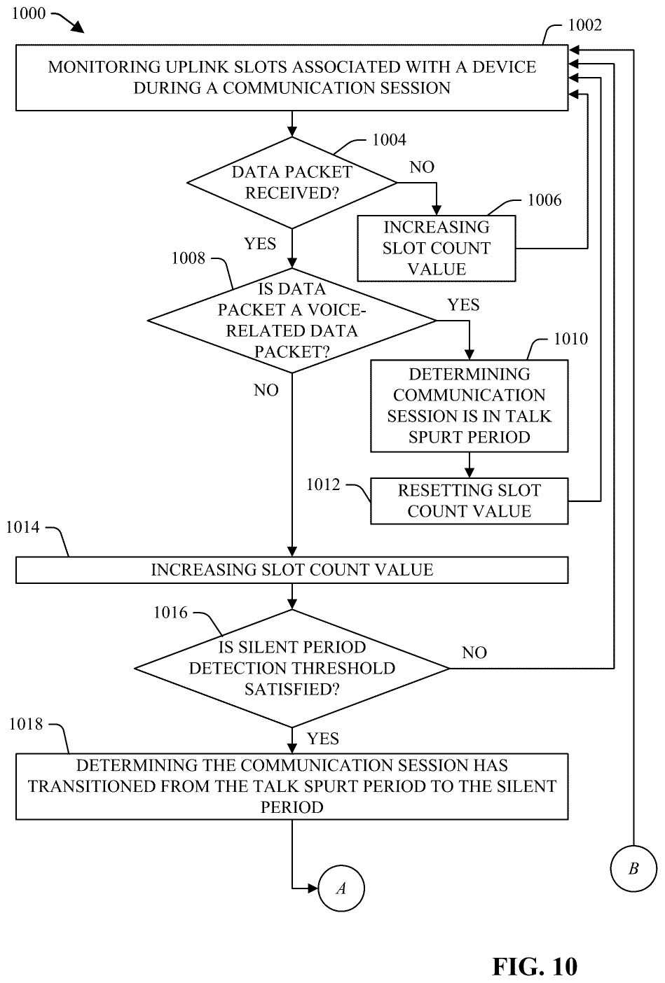

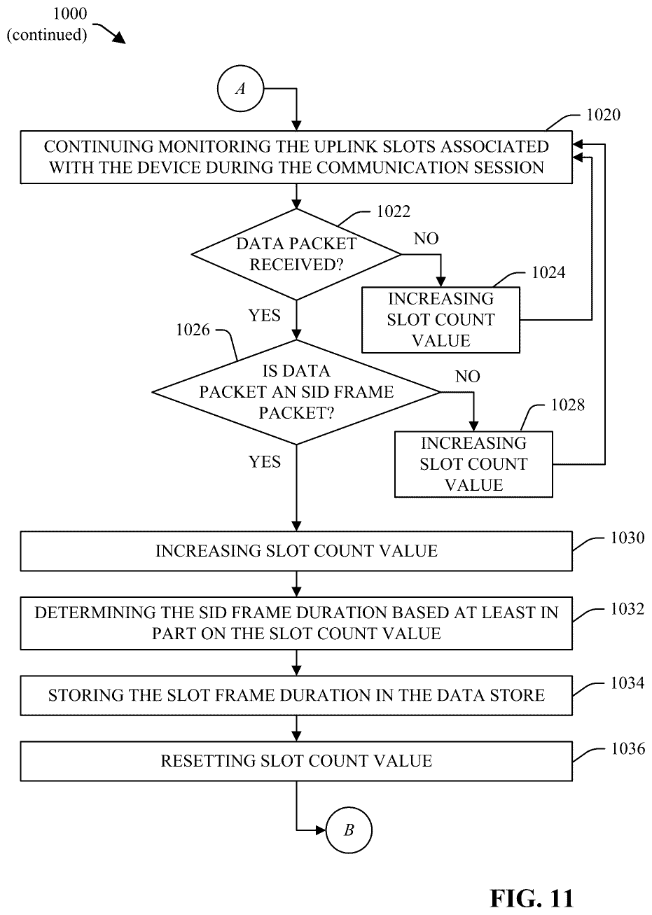

FIGS. 10 and 11 depict a flow chart of another example method 1000 that can desirably (e.g., automatically, dynamically, suitably, reliably, efficiently, enhancedly, and/or optimally) learn and determine (e.g., adaptively and/or continuously learn and determine) an SID frame duration of communication of SID frames by a device during a communication session of the device, in accordance with various aspects and embodiments of the disclosed subject matter. The method 1000 can be employed by, for example, a system comprising the uplink communication manager component, which can comprise or be associated with the processor component, the data store, and/or other components.

At 1002, uplink slots associated with a device during a communication session can be monitored. The device can be associated with (e.g., wirelessly communicatively connected to) a base station and utilizing a desired service (e.g., VoNR or other voice-related service) during a communication session. Initially, or at some point, the communication session, and the device, can be in a talk spurt period (e.g., talk spurt state) where the base station can be receiving voice-related data packets, associated with the service, in uplink grant slots (e.g., periodic uplink time slots or configured grant slots) from the device. The uplink communication manager component can monitor the uplink slots associated with the device during the communication session. Some of the slots can be associated with periodic uplink grants, if periodic uplink grants are being utilized with the service by the device, or can be associated with a configured grant, if the configured grant is being utilized with the service by the device, in accordance with a periodicity of the periodic uplink grant or the configured grant.

At 1004, a determination can be made regarding whether a data packet has been received in an uplink slot from the device. For instance, based at least in part on the monitoring, the uplink communication manager component, employing the frame duration detector component, can determine whether the base station has received, from the device, a data packet in an uplink slot (e.g., uplink time slot) associated with the communication session.

If it is determined that no data packet was received in the uplink slot under consideration, at 1006, a slot count value can be increased. If the frame duration detector component determines that no data packet was received in the uplink slot from the device by the base station, the frame duration detector component can increase (e.g., increment) the slot count value (e.g., by one). It is noted that, initially (e.g., prior to the first incrementing of the slot count value), the slot count value can be at a default slot count value (e.g., 0). The slot count value can indicate the number of consecutive slots where no voice-related data packet (or SID frame packet) has been received by the base station from the device during the communication session (e.g., the number of consecutive slots where no data packet or only a padding packet was received by the base station from the device). At this point, the method 1000 can return to reference numeral 1002, wherein the uplink slots associated with the device during the communication session can continue to be monitored, and the method 1000 can proceed from that point.

If, instead, at 1004, it is determined that a data packet has been received in the uplink slot under consideration, at 1008, a determination can be made regarding whether the data packet is a voice-related data packet. In some embodiments, the frame duration detector component can determine whether the data packet is a voice-related data packet or a padding packet based at least in part on the results of analyzing the data packet.

If it is determined that the data packet is a voice-related packet, at 1010, a determination can be made that the communication session is in (e.g., remains in) the talk spurt period. If the frame duration detector component determines that the data packet is the voice-related data packet, the frame duration detector component can determine that the communication session is in (e.g., remains in) the talk spurt period.

At 1012, the slot count value can be reset to the default slot count value. In response to determining that the data packet is the voice-related data packet, the frame duration detector component can reset the slot count value back to the default slot count value. At this point, the method 1000 can return to reference numeral 1002, wherein the uplink slots associated with the device during the communication session can continue to be monitored, and the method 1000 can proceed from that point.

If, instead, at 1008, it is determined that the data packet is not the voice-related data packet, at 1014, the slot count value can be increased. For instance, if the frame duration detector component determines that the data packet is not the voice-related data packet, the frame duration detector component can increase (e.g., increment) the slot count value (e.g., by one).

At 1016, a determination can be made regarding whether a silent period detection threshold value is satisfied. For instance, if the frame duration detector component determines that the data packet is not a voice-related data packet, but rather, is a padding packet, the frame duration detector component can determine whether the silent period detection threshold value (e.g., the threshold number of consecutive slots relating to (e.g., indicative of) the silent period) is satisfied (e.g., met, reached, attained, or achieved). The silent period detection threshold value can be the threshold number of consecutive slots without the base station receiving a voice-related data packet (or an SID frame packet) from the device to indicate whether the device and communication session have transitioned from the talk spurt period to the silent period. If the frame duration detector component determines that the number of consecutive slots without receiving a voice-related data packet (or an SID frame packet) from the device during the communication session satisfies the threshold number of consecutive slots, the frame duration detector component can determine that the communication session is in the silent period (e.g., has transitioned to or remains in the silent period). If, instead, the threshold number of consecutive slots is determined to not be satisfied (e.g., if the number of consecutive slots without receiving a voice-related packet or SID frame packet is less than the threshold number of consecutive slots), the frame duration detector component cannot yet determine whether the communication session is in the silent period.

If it is determined that the silent period detection threshold value is not satisfied, at this point, the method 1000 can return to reference numeral 1002, wherein the uplink slots associated with the device during the communication session can continue to be monitored, and the method 1000 can proceed from that point.

If, instead, at 1016, it is determined that the silent period detection threshold value has been satisfied, at 1018, a determination can be made that the communication session has transitioned from the talk spurt period to the silent period. For instance, if, instead, the frame duration detector component determines that the silent period detection threshold value has been satisfied, the frame duration detector component can determine that the communication session has transitioned from the talk spurt period to the silent period. At this point, the method 1000 can proceed to reference point A, wherein the method 1000 can continue from reference point A, as depicted in FIG. 11 and described herein.

At 1020, the uplink slots associated with the device during the communication session can continue to be monitored. While the communication session is in the silent period, the uplink communication manager component can continue to monitor the uplink slots associated with the device during the communication session.

At 1022, a determination can be made regarding whether a data packet has been received in an uplink slot from the device. For instance, based at least in part on the continued monitoring, the frame duration detector component can determine whether the base station has received, from the device, a data packet in an uplink slot associated with the communication session.

If it is determined that no data packet was received in the uplink slot under consideration, at 1024, the slot count value can be increased. If the frame duration detector component determines that no data packet was received in the uplink slot from the device by the base station, the frame duration detector component can increase (e.g., increment) the slot count value (e.g., by one). The slot count value can continue to be tracked to facilitate determining the number of consecutive uplink slots without the base station receiving an SID frame packet (or voice-related data packet) from the device during the silent period of the communication session, to facilitate determining the SID frame duration, such as described herein. At this point, the method 1000 can return to reference numeral 1020, wherein the uplink slots associated with the device during the communication session can continue to be monitored, and the method 1000 can proceed from that point.

If, instead, at 1022, it is determined that a data packet has been received in the uplink slot under consideration, at 1026, a determination can be made regarding whether the data packet is an SID frame packet (or voice-related data packet), or is instead a padding packet. In some embodiments, the frame duration detector component can determine whether the data packet is an SID frame packet (or voice-related data packet), or is instead a padding packet, based at least in part on the results of analyzing the data packet.

If it is determined that the data packet is not an SID frame packet (or voice-related data packet), at 1028, the slot count value can be increased. If the frame duration detector component determines that the data packet is not an SID frame packet (or voice-related data packet), but is instead a padding packet, the frame duration detector component can increase (e.g., increment) the slot count value (e.g., by one). At this point, the method 1000 can return to reference numeral 1020, wherein the uplink data packets being received in the uplink slots by the base station from the device during the communication session can continue to be monitored, and the method 1000 can proceed from that point.

If, instead, at 1026, it is determined that the data packet is an SID frame packet (or voice-related data packet), at 1030, the slot count value can be increased to account for the uplink slot in which the SID frame packet (or voice-related data packet) was received. For instance, if the frame duration detector component determines that the data packet received in the uplink slot from the device by the base station is the SID frame packet (or voice-related data packet), the frame duration detector component can increase (e.g., increment) the slot count value (e.g., by one) to account for the uplink slot wherein the SID frame packet (or voice-related data packet) was received.

At 1032, the SID frame duration can be determined based at least in part on the slot count value. For instance, if the frame duration detector component determines that the data packet is a voice-related data packet, the frame duration detector component can determine or assume that this voice-related data packet received during the silent period is an SID frame packet. The frame duration detector component can determine (e.g., calculate) the SID frame duration (e.g., SID frame duration period) based at least in part on (e.g., as a function of, or equal to) the slot count value, such as described herein. In some embodiments, the SID frame duration can be expressed as a number of consecutive slots (e.g., inclusive of the uplink slot wherein the SID frame packet was received) between the base station receiving a voice-related data packet (e.g., last voice-related data packet of a talk spurt period) in an uplink slot from the device and receiving an SID frame packet (e.g., first SID frame packet of the silent period that occurs immediately after the talk spurt period) in an uplink slot from the device, or can be expressed as a number of consecutive slots (e.g., inclusive of the uplink slot wherein a next SID frame packet was received) between the base station receiving an SID frame packet in an uplink slot from the device and receiving a next SID frame packet in an uplink slot from the device (e.g., which typically can be the same number of consecutive slots as the number of slots between receiving the last voice-related data packet of the talk spurt period and receiving the first SID frame packet of the silent period). In other embodiments, the SID frame duration can be expressed as an amount of time between an SID frame packet (or the last voice-related data packet before the silent period) and a next SID frame packet (e.g., the number of consecutive slots between an SID frame packet (or the last voice-related data packet) and a next SID frame packet multiplied by the periodicity of the slots). For instance, in an example scenario, during the silent period, after a last uplink slot without receiving the SID frame packet (or voice-related data packet) before receiving the SID frame packet (or voice-related data packet), the slot count value may be 319 slots. After receiving the SID frame packet (or voice-related data packet) in the current uplink slot, the frame duration detector component can increment (e.g., increase or add to) the slot count value by a desired value (e.g., 1) to result in the slot count value being 320 slots, to account for the uplink slot in which the SID frame packet (or voice-related data packet) was received. That is, the SID frame duration can reflect the difference, in number of slots, between when the last voice-related data packet was received during the talk spurt period and when the first SID frame packet was received during the silent period.

At 1034, the slot frame duration can be stored in the data store. The frame duration detector component can store the slot frame duration in the data store of or associated with the uplink communication manager component. The uplink communication manager component can utilize the SID frame duration to determine the number of slots, and as a result, the number of periodic uplink grants, that can be bypassed, if periodic uplink grants are being employed, or the number of configured grant slots that can be bypassed if the configured grant is being employed, such as described herein.

At 1036, the slot count value can be reset. For instance, in response to determining and storing the SID frame duration, the uplink communication manager component can reset the slot count value to the default value (e.g., zero or other desired default value). At this point, in some embodiments, the method 1000 can proceed to reference point B, wherein the method 1000 can proceed from reference point B, as depicted in FIG. 10, and return to reference numeral 1002, wherein the uplink slots associated with the device during the communication session can continue to be monitored, and the method 1000 can proceed from that point.

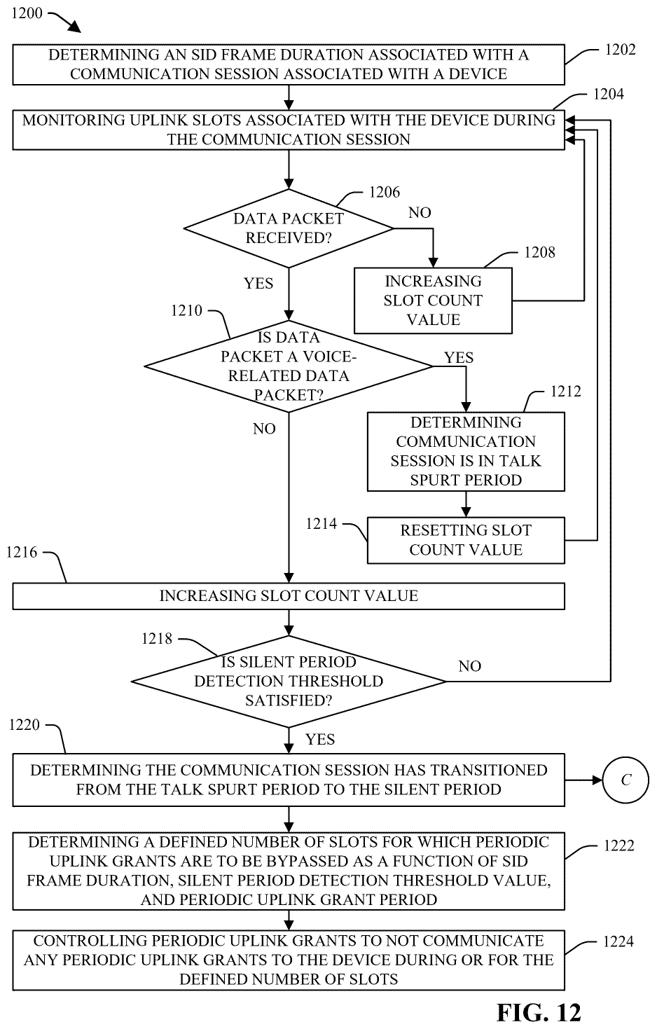

FIG. 12 illustrates a flow chart of an example method 1200 that can desirably (e.g., automatically, dynamically, suitably, reliably, efficiently, enhancedly, and/or optimally) determine an SID frame duration during a communication session of the device, determine whether the communication session is in a silent period, and control bypassing of periodic uplink grants during the silent period (e.g., based at least in part on the SID frame duration), to facilitate mitigating wastage of uplink air interface resources and/or other resources of the device or the communication network, in accordance with various aspects and embodiments of the disclosed subject matter. The method 1200 can be employed by, for example, a system (e.g., a device comprising the system) comprising the uplink communication manager component, which can comprise or be associated with the processor component, the data store, and/or other components.

At 1202, an SID frame duration associated with a communication session associated with a device and a base station can be determined based at least in part on a number of consecutive slots without the base station receiving a voice-related data packet or SID frame packet during a silent period of the communication session. For instance, the frame duration detector component can determine when the communication session has transitioned from the talk spurt period to the silent period, such as described herein. The frame duration detector component also can determine (e.g., calculate) the SID frame duration (e.g., SID frame duration period) based at least in part on (e.g., as a function of) the slot count value indicating the number of consecutive slots without the base station receiving a voice-related data packet or SID frame packet during the silent period of the communication session, such as described herein.

At 1204, uplink slots associated with the device during the communication session can be monitored. The uplink communication manager component can monitor the uplink slots (e.g., uplink time slots) associated with the device during the communication session. In some embodiments, some of the uplink slots can be associated with periodic uplink grants, wherein the device can utilize the periodic uplink grants to determine which uplink slots are to be utilized by the device to communicate data packets to the base station. While the uplink slots are being monitored, the communication session may be in the talk spurt period or the silent period. The uplink communication manager component can monitor the uplink slots, and the data packets received in some of the uplink slots, to determine whether the communication session remains in the talk spurt period or has transitioned from the talk spurt period to the silent period, if the communication session has been in the talk spurt period; or determine whether the communication session remains in the silent period or has transitioned from the silent period to a next talk spurt period, if the communication session has been in the silent period.

At 1206, a determination can be made regarding whether a data packet has been received in an uplink slot from the device. For instance, based at least in part on the monitoring, the frame duration detector component can determine whether the base station has received, from the device, a data packet in an uplink slot associated with the communication session.

If it is determined that no data packet was received in the uplink slot under consideration, at 1208, a slot count value can be increased. If the frame duration detector component determines that no data packet was received in the uplink slot by the base station from the device, the frame duration detector component can increase (e.g., increment) the slot count value (e.g., by one). It is noted that, initially (e.g., prior to the first incrementing of the slot count value), the slot count value can be at the default (or reset) slot count value (e.g., 0). At this point, the method 1200 can return to reference numeral 1204, wherein the uplink slots associated with the device during the communication session can continue to be monitored, and the method 1200 can proceed from that point.

If, instead, at 1206, it is determined that a data packet has been received in the uplink slot under consideration, at 1210, a determination can be made regarding whether the data packet is a voice-related data packet. In some embodiments, the frame duration detector component can determine whether the data packet is a voice-related data packet or a padding packet based at least in part on the results of analyzing the data packet.

If it is determined that the data packet is a voice-related packet, at 1212, a determination can be made that the communication session is in (e.g., remains in) the talk spurt state. If the frame duration detector component determines that the data packet is the voice-related data packet, the frame duration detector component can determine that the communication session is in (e.g., remains in) the talk spurt state.

At 1214, the slot count value can be reset to the default slot count value. In response to determining that the data packet is the voice-related data packet, the frame duration detector component can reset the slot count value back to the default slot count value. At this point, the method 1200 can return to reference numeral 1204, wherein the uplink slots associated with the device during the communication session can continue to be monitored, and the method 1200 can proceed from that point.

If, instead, at 1210, it is determined that the data packet is not the voice-related data packet, at 1216, the slot count value can be increased. For instance, if the frame duration detector component determines that the data packet is not the voice-related data packet, the frame duration detector component can increase (e.g., increment) the slot count value (e.g., by one).

At 1218, a determination can be made regarding whether a silent period detection threshold value is satisfied. For instance, if the frame duration detector component determines that the data packet is not a voice-related data packet, but rather, is a padding packet, the frame duration detector component can determine whether the silent period detection threshold value (e.g., the threshold number of consecutive slots relating to the silent period) is satisfied.

If it is determined that the silent period detection threshold value is not satisfied, at this point, the method 1200 can return to reference numeral 1204, wherein the uplink slots associated with the device during the communication session can continue to be monitored, and the method 1200 can proceed from that point.

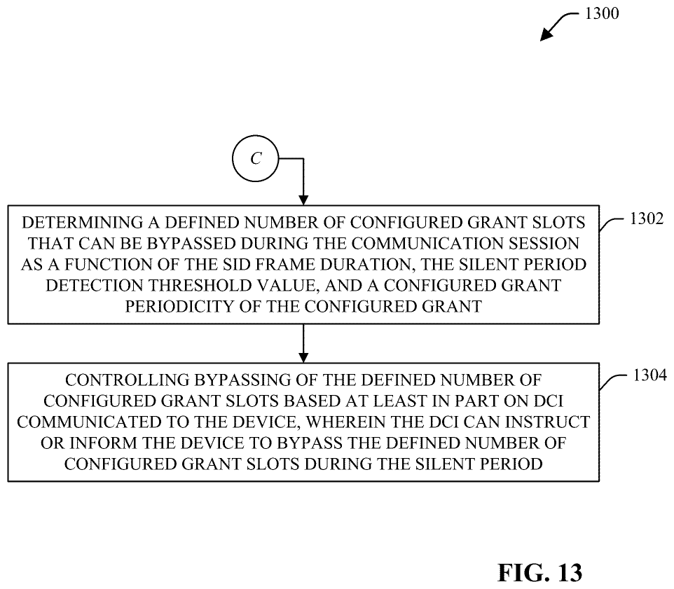

If, instead, at 1218, it is determined that the silent period detection threshold value has been satisfied, at 1220, a determination can be made that the communication session has transitioned from the talk spurt period to the silent period. For instance, if the frame duration detector component determines that the silent period detection threshold value has been satisfied, the frame duration detector component can determine that the communication session has transitioned from the talk spurt period to the silent period. In some embodiments, if periodic uplink grants are being employed during the communication session, the method 1200 can proceed to reference numeral 1222. In other embodiments, if a configured grant is being employed during the communication session, the method 1200 can proceed to reference point C, wherein method 1300, as depicted in FIG. 13, can proceed from reference point C, such as described herein.

At 1222, a defined number of slots for which periodic uplink grants are to be bypassed during the communication session can be determined as a function of the SID frame duration, the silent period detection threshold value, and a periodic uplink grant period of the periodic uplink grants associated with the communication session. For instance, the uplink communication manager component can determine (e.g., calculate) the defined number of slots for which one or more periodic uplink grants are to be bypassed as a function of the SID frame duration, the threshold number of consecutive slots relating to the silent period (e.g., the silent period detection threshold value), and the periodic uplink grant period (e.g., the SID frame duration (e.g., the number of slots of the SID frame duration)—the silent period detection threshold value—the periodic uplink grant period), such as described herein.

At 1224, periodic uplink grants can be controlled to not communicate any periodic uplink grants to the device during or for the defined number of slots. In some embodiments, the uplink communication manager component, employing the slot bypasser controller component, can control communication of periodic uplink grants to not communicate any periodic uplink grants to the device during or for the defined number of slots, which can be the remaining portion of the SID frame duration until the next SID frame (or a voice-related data packet) is expected to be received. As a result of not receiving uplink grants for the defined number of slots, the device can bypass communicating, or can otherwise not communicate, data (e.g., padding packets) for the defined number of slots. Given the determined SID frame duration, after the defined number of slots, the base station (and the uplink communication manager component) can expect to receive a next SID frame (e.g., after the current SID frame duration period ends), if the silent period is to continue, or a next voice-related data packet, if the communication session is transitioning from the silent period to the next talk spurt state.

FIG. 13 illustrates a flow chart of an example method 1300 that can desirably (e.g., automatically, dynamically, suitably, reliably, efficiently, enhancedly, and/or optimally) determine an SID frame duration during a communication session of the device, determine whether the communication session is in a silent period, and control bypassing of configured grant slots during the silent period (e.g., based at least in part on the SID frame duration), to facilitate mitigating wastage of uplink air interface resources and/or other resources of the device or the communication network, in accordance with various aspects and embodiments of the disclosed subject matter. The method 1300 can be employed by, for example, a system (e.g., a device comprising the system) comprising the uplink communication manager component, which can comprise or be associated with the processor component, the data store, and/or other components.

In certain embodiments, the method 1300 can proceed from reference point C of the method 1200, as depicted in FIG. 12, wherein, at reference point C, the SID frame duration has been determined, and it has been determined that the communication session is in the silent period (e.g., the communication session has transitioned from a talk spurt period to the silent period; or the communication session already was in the silent period and is remaining in the silent period). The method 1300 can be employed when a configured grant is being employed for the communication session.

At 1302, a defined number of configured grant slots that can be bypassed during the communication session can be determined as a function of the SID frame duration, the silent period detection threshold value, and a configured grant periodicity of the configured grant. For instance, the uplink communication manager component can determine (e.g., calculate) the defined number of configured grant slots that can be bypassed during the communication session (e.g., during the remaining portion of the SID frame duration of this portion of the silent period of the communication session) as a function of the SID frame duration, the silent period detection threshold value (e.g., the threshold number of consecutive slots relating to the silent period), and the configured grant periodicity of the configured grant (e.g., ((SID frame duration-silent period detection threshold value)/configured grant periodicity)−1)).

At 1304, bypassing of the defined number of configured grant slots can be controlled based at least in part on DCI communicated to the device, wherein the DCI can instruct or inform the device to bypass the defined number of configured grant slots during the silent period. The uplink communication manager component, employing the slot bypasser controller component, can initiate and control bypassing of the defined number of configured grant slots by communicating DCI to the device, wherein the DCI can instruct or inform the device to bypass the defined number of configured grant slots during the silent period (e.g., during the remaining portion of the SID frame duration of this portion of the silent period of the communication session). Based at least in part on the DCI, the device, employing the slot bypasser component of the device, can reconfigure the configured grant to bypass the defined number of configured grant slots during the silent period. As a result of such bypassing, the device can bypass communicating, or can otherwise not communicate, data (e.g., padding) for the defined number of configured grant slots during the silent period. Given the determined SID frame duration, after the defined number of configured grant slots, the base station (and the uplink communication manager component) can expect to receive a next SID frame (e.g., after the current SID frame duration period ends), if the silent period is to continue, or a next voice-related data packet, if the communication session is transitioning from the silent period back to the next talk spurt state.

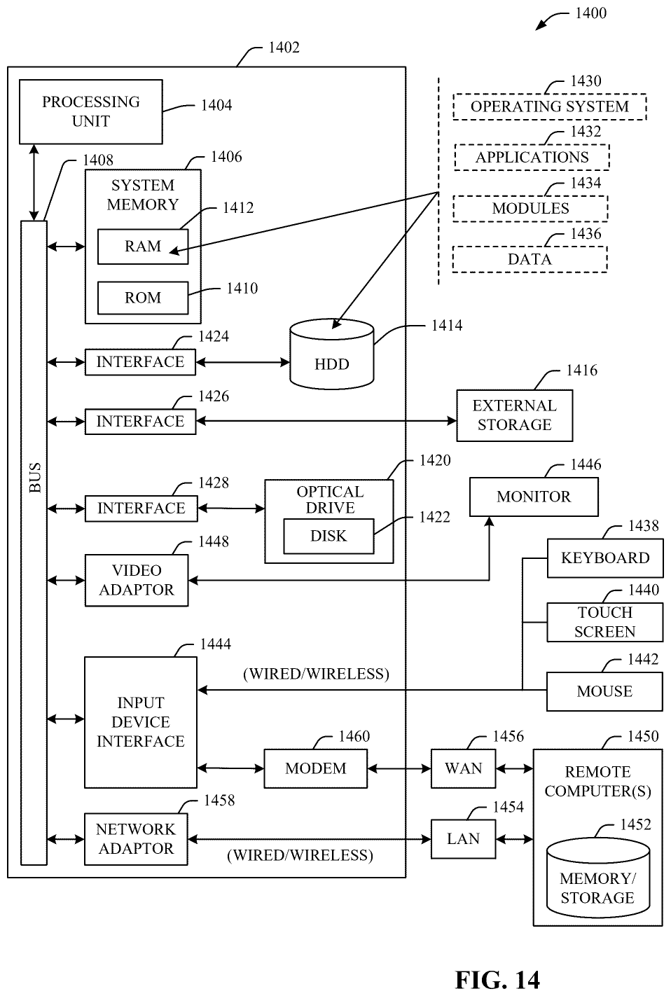

In order to provide additional context for various embodiments described herein, FIG. 14 and the following discussion are intended to provide a brief, general description of a suitable computing environment 1400 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 also can be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456, e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, uplink communication manager component, slot bypasser component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
determining, by a system comprising at least one processor, a silent-insertion-descriptor frame duration associated with a communication session associated with a device based on a determination of a number of consecutive time slots without an uplink voice-related data packet or a silent-insertion-descriptor frame packet being received from the device during the communication session; and
initiating, by the system, bypassing of at least one uplink grant time slot for the communication session for a defined time period that is determined based on the silent-insertion-descriptor frame duration.

2. The method of claim 1, wherein the uplink voice-related data packet or the silent-insertion-descriptor frame packet comprises a voice-related protocol data unit.

3. The method of claim 1, wherein the at least one uplink grant time slot is associated with a periodic uplink grant or a configured grant.

4. The method of claim 1, further comprising:
receiving, by the system, the uplink voice-related data packet from the device during a first uplink grant time slot of the communication session; and
receiving, by the system, the silent-insertion-descriptor frame packet from the device during a second uplink grant time slot of the communication session, wherein no uplink voice-related data packet and no silent-insertion-descriptor frame packet is received from the device for the number of consecutive time slots between the receiving of the uplink voice-related data packet and the receiving of the silent-insertion-descriptor frame packet.

5. The method of claim 1, further comprising:
monitoring, by the system, data packets received from the device during the communication session;
in response to receiving a data packet in a time slot from the device, determining, by the system, that the data packet is not the uplink voice-related data packet and not the silent-insertion-descriptor frame packet; and
determining, by the system, whether no uplink voice-related data packet and no silent-insertion-descriptor frame packet has been received from the device for at least a threshold number of consecutive time slots relating to a silent period.

6. The method of claim 5, further comprising:
determining that the threshold number of consecutive time slots relating to the silent period has not been satisfied based on determining that the number of consecutive time slots without the uplink voice-related data packet or the silent-insertion-descriptor frame packet being received from the device during the communication session does not satisfy the threshold number of consecutive time slots relating to the silent period, and in response to determining that the threshold number of consecutive time slots has not been satisfied, determining, by the system, that the silent period has not commenced; or
determining that the threshold number of consecutive time slots relating to the silent period has been satisfied based on determining that no uplink voice-related data packet and no silent-insertion-descriptor frame packet has been received from the device for at least the threshold number of consecutive time slots, and
in response to determining that the threshold number of consecutive time slots relating to the silent period has been satisfied, determining, by the system, that the silent period has commenced.

7. The method of claim 6, wherein the determining of the silent-insertion-descriptor frame duration comprises: in response to determining that the silent period has commenced, determining the silent-insertion-descriptor frame duration associated with the communication session associated with the device based on the determination of the number of consecutive time slots without the uplink voice-related data packet or the silent-insertion-descriptor frame packet being received from the device during the silent period of the communication session.

8. The method of claim 1, wherein at least the one uplink grant time slot is at least one periodic uplink grant time slot relating to periodic uplink grants associated with the communication session, and wherein the method further comprises:
determining, by the system, that a silent period has commenced based on the number of consecutive time slots without the uplink voice-related data packet or the silent-insertion-descriptor frame packet being received from the device being determined to satisfy a threshold number of consecutive time slots relating to the silent period; and
in response to determining that the silent period has commenced, determining, by the system, a defined number of time slots for which at least the one periodic uplink grant time slot is to be bypassed as a function of the silent-insertion-descriptor frame duration, the threshold number of consecutive time slots relating to the silent period, and a periodic uplink grant period of the periodic uplink grants associated with the communication session,
wherein the initiating of the bypassing comprises initiating bypassing of one or more periodic uplink grant time slots during the defined number of time slots, and wherein at least the one periodic uplink grant time slot comprises the one or more periodic uplink grant time slots.

9. The method of claim 8, further comprising:
to facilitate the bypassing, controlling, by the system, communication of the periodic uplink grants to not communicate any of the periodic uplink grants to the device during the defined number of time slots.

10. The method of claim 1, wherein at least the one uplink grant time slot is at least one configured grant time slot relating to a configured grant associated with the communication session, and wherein the method further comprises:
determining, by the system, that a silent period has commenced based on the number of consecutive time slots without the uplink voice-related data packet or the silent-insertion-descriptor frame packet being received from the device being determined to satisfy a threshold number of consecutive time slots relating to the silent period; and
in response to determining that the silent period has commenced, determining, by the system, a defined number of configured grant time slots to be bypassed as a function of the silent-insertion-descriptor frame duration, the threshold number of consecutive time slots relating to the silent period, and a configured grant periodicity of the configured grant associated with the communication session,
wherein the initiating of the bypassing comprises initiating bypassing of the defined number of configured grant time slots during the silent period, and wherein at least the one configured grant time slot comprises the defined number of configured grant time slots.

11. The method of claim 10, further comprising:
to facilitate the bypassing, communicating, by the system, downlink control information to the device, wherein the downlink control information instructs or informs the device to bypass the defined number of configured grant time slots during the silent period.

12. The method of claim 1, wherein the device is a first device, wherein the communication session is a first communication session, wherein at least the one uplink grant time slot is one or more time slots that are bypassed and not utilized by the device during the first communication session, and wherein the method further comprises:
allocating the one or more time slots and resources associated with the one or more time slots to a second device associated with a second communication session.

13. A system, comprising:
at least one memory that stores computer executable components; and
at least one processor that executes computer executable components stored in the at least one memory, wherein the computer executable components comprise:
a frame duration detector that determines a silent-insertion-descriptor frame duration associated with a communication session associated with a user equipment based on a determination of a number of consecutive slots determined not to comprise an uplink voice-related data packet or a silent-insertion-descriptor frame packet from the user equipment during the communication session; and
a slot bypasser controller that controls bypassing of at least one uplink grant slot for the communication session for a defined amount of time that is determined based on the silent-insertion-descriptor frame duration.

14. The system of claim 13, wherein the uplink voice-related data packet or the silent-insertion-descriptor frame packet comprises a voice-related protocol data unit.

15. The system of claim 13, wherein at least the one uplink grant slot is at least one periodic uplink grant slot relating to periodic uplink grants associated with the communication session, and wherein the computer executable components further comprise:
a silent period detector that determines a silent period has been initiated based on the number of consecutive slots without the uplink voice-related data packet or the silent-insertion-descriptor frame packet being received from the user equipment being determined to satisfy a threshold number of consecutive slots indicative of the silent period,
wherein, in response to the silent period detector determining that the silent period has been initiated, the slot bypasser controller determines a defined number of slots for which at least the one periodic uplink grant slot is to be bypassed based on the silent-insertion-descriptor frame duration, the threshold number of consecutive slots indicative of the silent period, or a periodic uplink grant period of the periodic uplink grants associated with the communication session,
wherein the slot bypasser controller controls bypassing of one or more periodic uplink grant slots during the defined number of slots, and wherein at least the one periodic uplink grant slot comprises the one or more periodic uplink grant slots.

16. The system of claim 15, wherein, to facilitate the bypassing, the slot bypasser controller controls communication of the periodic uplink grants to not communicate any of the periodic uplink grants to the user equipment during the defined number of slots.

17. The system of claim 13, wherein at least the one uplink grant slot is at least one configured grant slot relating to a configured grant associated with the communication session, and wherein the computer executable components further comprise:
a silent period detector that determines a silent period has been initiated based on the number of consecutive slots without the uplink voice-related data packet or the silent-insertion-descriptor frame packet being received from the user equipment being determined to satisfy a threshold number of consecutive slots relating to the silent period,
wherein, in response to the silent period detector determining that the silent period has been initiated, the slot bypasser controller determines a defined number of configured grant slots to be bypassed as a function of the silent-insertion-descriptor frame duration, the threshold number of consecutive slots relating to the silent period, or a configured grant periodicity of the configured grant associated with the communication session,
wherein the slot bypasser controller controls bypassing of the defined number of configured grant slots during the silent period, and wherein at least the one configured grant slot comprises the defined number of configured grant slots.

18. The system of claim 17, wherein, to facilitate the bypassing, the slot bypasser controller communicates downlink control information to the user equipment, and wherein the downlink control information instructs or informs the user equipment to bypass the defined number of configured grant slots during the silent period.

19. A non-transitory machine-readable medium, comprising executable instructions that, when executed by at least one processor, facilitate performance of operations, comprising:
determining a silent-insertion-descriptor frame duration associated with a silent period of a communication session associated with a user equipment based on a determination of a number of slots without an uplink voice-related data packet or a silent-insertion-descriptor frame packet being received from the user equipment during the communication session; and
initiating omission of an uplink grant slot during the silent period of the communication session for a defined time period that is determined based on the silent-insertion-descriptor frame duration.

20. The non-transitory machine-readable medium of claim 19, wherein the uplink grant slot is a periodic uplink grant slot associated with a periodic uplink grant or a configured grant slot associated with a configured grant, and wherein the operations further comprise:
determining a defined number of slots for which the periodic uplink grant slot is to be omitted as a function of the silent-insertion-descriptor frame duration, a threshold number of consecutive slots indicative of the silent period, or a periodic uplink grant period of the periodic uplink grants associated with the communication session, and
to facilitate omission of the periodic uplink grant slot, controlling communication of the periodic uplink grants to not communicate any of the periodic uplink grants to the user equipment during the defined number of slots; or
determining a defined number of configured grant slots, comprising the configured grant slot, to be omitted as a function of the silent-insertion-descriptor frame duration, the threshold number of consecutive slots indicative of the silent period, or a configured grant periodicity of the configured grant associated with the communication session, and
to facilitate the omission of the defined number of configured grant slots, communicating downlink control information to the user equipment, wherein the downlink control information instructs or informs the user equipment to omit the defined number of configured grant slots during the silent period.
